(19) United States
(12) Patent Application Publication
(10) Pub. No.: US 2026/0245254 A1
(43) Pub. Date: Aug. 20, 2026

(54) ENCAPSULATION OF VOLUMETRIC VIDEO WITH STATIC AND DYNAMIC TYPE COMPONENTS

(71) Applicant: Nokia Technologies Oy, Espoo (FI)

(72) Inventors: Lukasz KONDRAD, Munich (DE); Kashyap KAMMACHI SREEDHAR, Tampere (FI); Lauri Aleksi ILOLA, Tampere (FI); Emre Baris AKSU, Tampere (FI); Miska Matias HANNUKSELA, Tampere (FI); Patrice RONDAO ALFACE, Antwerp (BE)

(21) Appl. No.: 19/470,954

(22) PCT Filed: Mar. 4, 2024
(86) PCT No.: PCT/IB2024/052088

§ 371 Date: Sep. 30, 2025

Related U.S. Application Data
(60) Provisional application No. 63/456,073, filed on Mar. 31, 2023.

(51) Int. Cl. G06T 9/00; H04N 19/184; H04N 19/70

(52) U.S. Cl. CPC G06T 9/001; H04N 19/184; H04N 19/70

(57) ABSTRACT

An obtained bitstream includes two or more components, wherein at least one of the two or more component of the bitstream includes timed data, and wherein at least one of the two or more components of the bitstream includes non-timed data. The bitstream is encapsulated into a time-based multimedia data file including at least one non-timed structure and at least one timed structure. The at least one non-timed structure includes non-timed component(s) of the bitstream, and the at least one timed structure includes timed component(s) of the bitstream. Dependency between non-timed structure(s) and timed structure(s) is signaled. For example, the signaled dependency is from the non-timed structure(s) to the timed structure(s) or vice versa. A time-based multimedia data file is received and parsed to determine first and second information, and an extracted bitstream is formed therefrom.

### TECHNICAL FIELD

Examples of embodiments herein relate generally to video encoding and decoding and, more specifically, relate to encapsulation of volumetric video with static and dynamic type components.

### BACKGROUND

Volumetric video represents a new way of experiencing immersive media content. This refers to the process of capturing objects (e.g., people) from multiple cameras, which can be later viewed from any angle at any point in time.

There are many ways to capture and represent a volumetric frame of this video. The format used to capture and represent the volumetric frame depends on the processing to be performed on the frame, and the target application using the frame.

For video encoding and decoding, there are “timed” objects and “non-timed” (or “untimed”) objects. The timed objects are dynamic, and have a timed data that change over time and require timed processing. Timed data typically have assigned decoding, and/or composition, and/or presentation time. An example of timed object may be a video sequence of decoded frames presented at a predefined time (or times) to an end user. By contrast, the non-timed objects are static, represented by non-timed data that do not change over time, and do not require timed processing. An example of a non-timed object may be a single image that does not have any information about decoding or presentation time, or metadata (e.g., data about the video content).

Any format used to capture and represent volumetric frames may address both objects.

### BRIEF SUMMARY

This section is intended to include examples and is not intended to be limiting.

In an example embodiment, a method is disclosed that includes obtaining a bitstream, wherein the bitstream comprises two or more components, wherein at least one of the two or more component of the bitstream includes timed data, and wherein at least one of the two or more components of the bitstream includes non-timed data. The method includes encapsulating the bitstream into a time-based multimedia data file including at least one non-timed structure and at least one timed structure, wherein the at least one non-timed structure includes one or more non-timed components of the bitstream, and wherein the at least one timed structure includes one or more timed components of the bitstream. The method includes signaling dependency between one or more of the at least one non-timed structure and one or more of the at least one timed structure, wherein the signaled dependency is from the one or more non-timed structures to the one or more timed structures or is from the one or more timed structures to the one or more non-timed structures.

An additional example embodiment includes a computer program, comprising instructions for performing the method of the previous paragraph, when the computer program is run on an apparatus. The computer program according to this paragraph, wherein the computer program is a computer program product comprising a computer-readable medium bearing the instructions embodied therein for use with the apparatus. Another example is the computer program according to this paragraph, wherein the program is directly loadable into an internal memory of the apparatus.

An example apparatus includes one or more processors and one or more memories storing instructions that, when executed by the one or more processors, cause the apparatus at least to perform: obtaining a bitstream, wherein the bitstream comprises two or more components, wherein at least one of the two or more component of the bitstream includes timed data, and wherein at least one of the two or more components of the bitstream includes non-timed data; encapsulating the bitstream into a time-based multimedia data file including at least one non-timed structure and at least one timed structure, wherein the at least one non-timed structure includes one or more non-timed components of the bitstream, and wherein the at least one timed structure includes one or more timed components of the bitstream; and signaling dependency between one or more of the at least one non-timed structure and one or more of the at least one timed structure, wherein the signaled dependency is from the one or more non-timed structures to the one or more timed structures or is from the one or more timed structures to the one or more non-timed structures.

An example computer program product includes a computer-readable storage medium bearing instructions that, when executed by an apparatus, cause the apparatus to perform at least the following: obtaining a bitstream, wherein the bitstream comprises two or more components, wherein at least one of the two or more component of the bitstream includes timed data, and wherein at least one of the two or more components of the bitstream includes non-timed data; encapsulating the bitstream into a time-based multimedia data file including at least one non-timed structure and at least one timed structure, wherein the at least one non-timed structure includes one or more non-timed components of the bitstream, and wherein the at least one timed structure includes one or more timed components of the bitstream; and signaling dependency between one or more of the at least one non-timed structure and one or more of the at least one timed structure, wherein the signaled dependency is from the one or more non-timed structures to the one or more timed structures or is from the one or more timed structures to the one or more non-timed structures.

In another example embodiment, an apparatus comprises means for performing: obtaining a bitstream, wherein the bitstream comprises two or more components, wherein at least one of the two or more component of the bitstream includes timed data, and wherein at least one of the two or more components of the bitstream includes non-timed data; encapsulating the bitstream into a time-based multimedia data file including at least one non-timed structure and at least one timed structure, wherein the at least one non-timed structure includes one or more non-timed components of the bitstream, and wherein the at least one timed structure includes one or more timed components of the bitstream; and signaling dependency between one or more of the at least one non-timed structure and one or more of the at least one timed structure, wherein the signaled dependency is from the one or more non-timed structures to the one or more timed structures or is from the one or more timed structures to the one or more non-timed structures.

In an example embodiment, a method is disclosed that includes receiving a time-based multimedia data file in a bitstream including at least one non-timed structure, at least one timed structure, and signaling information, wherein the at least one non-timed structure includes one or more non-timed components of the bitstream, and wherein the at least one timed structure includes one or more timed components of the bitstream, and wherein the signaling information includes dependency information between at least one non-timed structure and at least one timed structure. The method also includes parsing the received time-based multimedia data file to retrieve first information, comprising the at least one non-timed structure including the one or more non-timed components of the bitstream, and to retrieve second information, comprising the at least one timed structure including the one or more timed components of the bitstream, based on a signaled dependency identified through the signaling information. The method further includes forming an extracted bitstream based on the retrieved first and second information.

An additional example embodiment includes a computer program, comprising instructions for performing the method of the previous paragraph, when the computer program is run on an apparatus. The computer program according to this paragraph, wherein the computer program is a computer program product comprising a computer-readable medium bearing the instructions embodied therein for use with the apparatus. Another example is the computer program according to this paragraph, wherein the program is directly loadable into an internal memory of the apparatus.

An example apparatus includes one or more processors and one or more memories storing instructions that, when executed by the one or more processors, cause the apparatus at least to perform: receiving a time-based multimedia data file in a bitstream including at least one non-timed structure, at least one timed structure, and signaling information, wherein the at least one non-timed structure includes one or more non-timed components of the bitstream, and wherein the at least one timed structure includes one or more timed components of the bitstream, and wherein the signaling information includes dependency information between at least one non-timed structure and at least one timed structure; parsing the received time-based multimedia data file to retrieve first information, comprising the at least one non-timed structure including the one or more non-timed components of the bitstream, and to retrieve second information, comprising the at least one timed structure including the one or more timed components of the bitstream, based on a signaled dependency identified through the signaling information; and forming an extracted bitstream based on the retrieved first and second information.

An example computer program product includes a computer-readable storage medium bearing instructions that, when executed by an apparatus, cause the apparatus to perform at least the following: receiving a time-based multimedia data file in a bitstream including at least one non-timed structure, at least one timed structure, and signaling information, wherein the at least one non-timed structure includes one or more non-timed components of the bitstream, and wherein the at least one timed structure includes one or more timed components of the bitstream, and wherein the signaling information includes dependency information between at least one non-timed structure and at least one timed structure; parsing the received time-based multimedia data file to retrieve first information, comprising the at least one non-timed structure including the one or more non-timed components of the bitstream, and to retrieve second information, comprising the at least one timed structure including the one or more timed components of the bitstream, based on a signaled dependency identified through the signaling information; and forming an extracted bitstream based on the retrieved first and second information.

In another example embodiment, an apparatus comprises means for performing: receiving a time-based multimedia data file in a bitstream including at least one non-timed structure, at least one timed structure, and signaling information, wherein the at least one non-timed structure includes one or more non-timed components of the bitstream, and wherein the at least one timed structure includes one or more timed components of the bitstream, and wherein the signaling information includes dependency information between at least one non-timed structure and at least one timed structure; parsing the received time-based multimedia data file to retrieve first information, comprising the at least one non-timed structure including the one or more non-timed components of the bitstream, and to retrieve second information, comprising the at least one timed structure including the one or more timed components of the bitstream, based on a signaled dependency identified through the signaling information; and forming an extracted bitstream based on the retrieved first and second information.

An example method, comprises: obtaining a bitstream, wherein the bitstream comprises two or more components, wherein at least one of the two or more component of the bitstream comprises timed data, and wherein at least one of the two or more components of the bitstream comprises non-timed data; encapsulating the bitstream into a time-based multimedia data file comprising at least one non-timed structure and at least one timed structure, wherein the at least one non-timed structure comprises one or more non-timed components of the bitstream, and wherein the at least one timed structure comprises one or more timed components of the bitstream; and signaling dependency between one or more of the at least one non-timed structure and one or more of the at least one timed structure.

An example apparatus comprises at least one processor; and at least one non-transitory memory comprising computer program code; wherein the at least one memory and the computer program code are configured to, with the at least one processor, cause the apparatus at least to perform: obtaining a bitstream, wherein the bitstream comprises two or more components, wherein at least one of the two or more component of the bitstream comprises timed data, and wherein at least one of the two or more components of the bitstream comprises non-timed data; encapsulating the bitstream into a time-based multimedia data file comprising at least one non-timed structure and at least one timed structure, wherein the at least one non-timed structure comprises one or more non-timed components of the bitstream, and wherein the at least one timed structure comprises one or more timed components of the bitstream; and signaling dependency between one or more of the at least one non-timed structure and one or more of the at least one timed structure. brief description of the drawings

In the attached drawings:

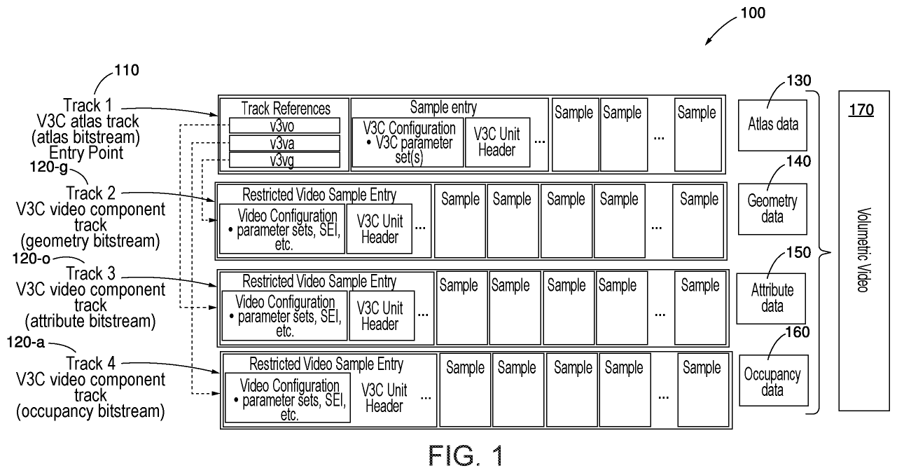

FIG. 1 is a block diagram of an overview of structure for encapsulating timed V3C data with a single atlas with a single atlas tile;

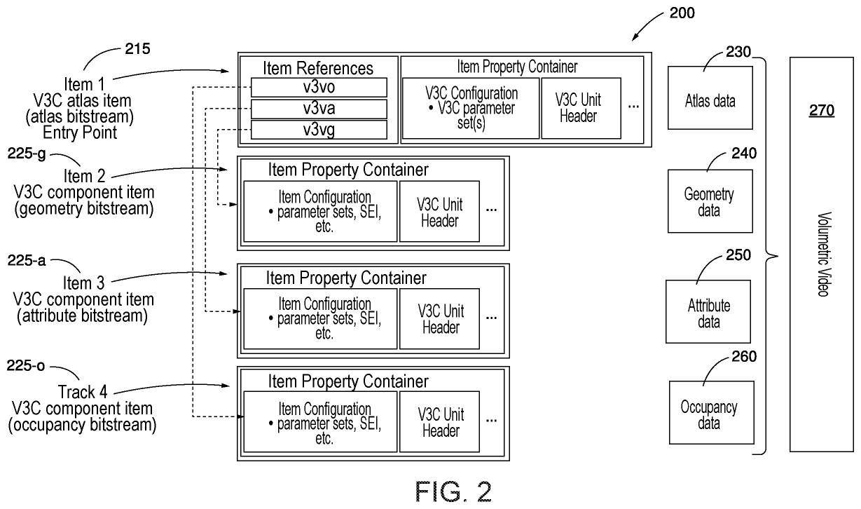

FIG. 2 is a block diagram of an overview of structure for encapsulating non-timed V3C data with a single atlas with a single atlas tile;

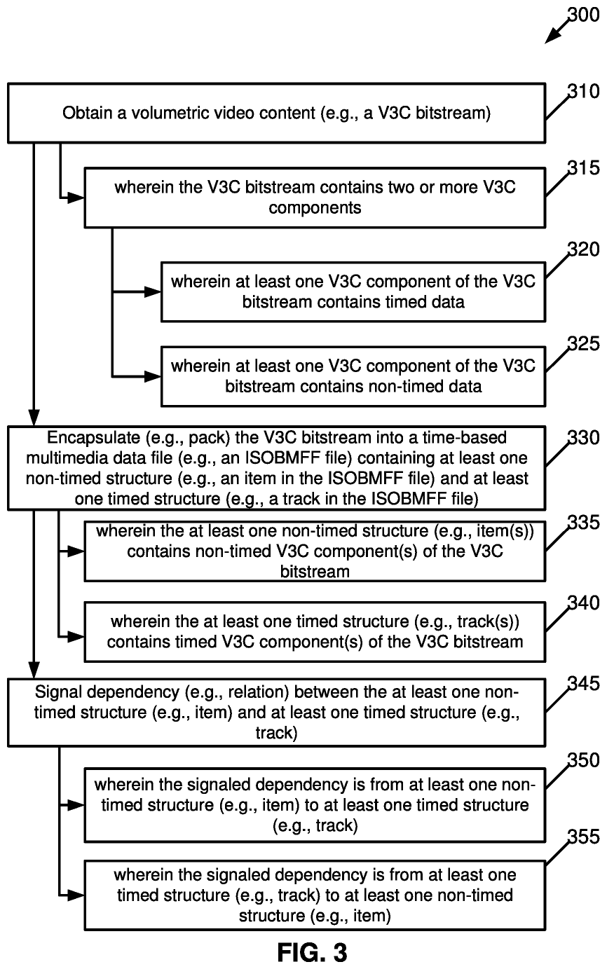

FIG. 3 is a flowchart of an example of an encapsulation process that performs encapsulation of volumetric video with static and dynamic type components;

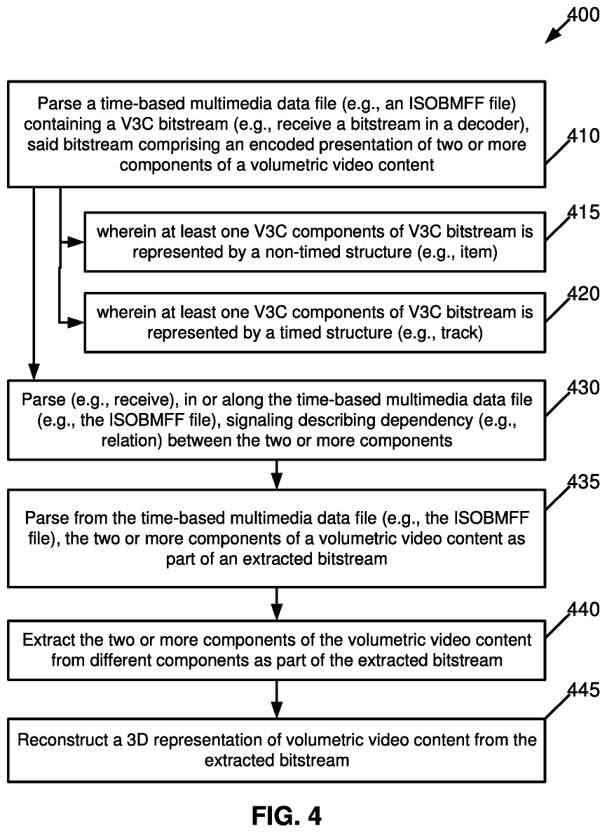

FIG. 4 is a flowchart of an example of a decoding process that decodes encapsulated volumetric video with static and dynamic type components;

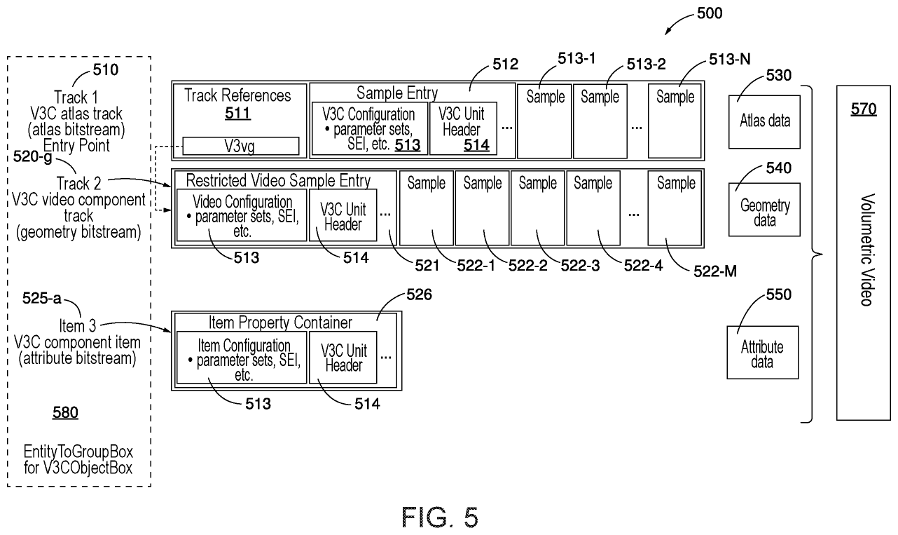

FIG. 5 is a block diagram of an example of ‘v3c’ entity to group box to indicate dependencies between timed tracks including atlas and geometry components and non-timed items that includes attribute components;

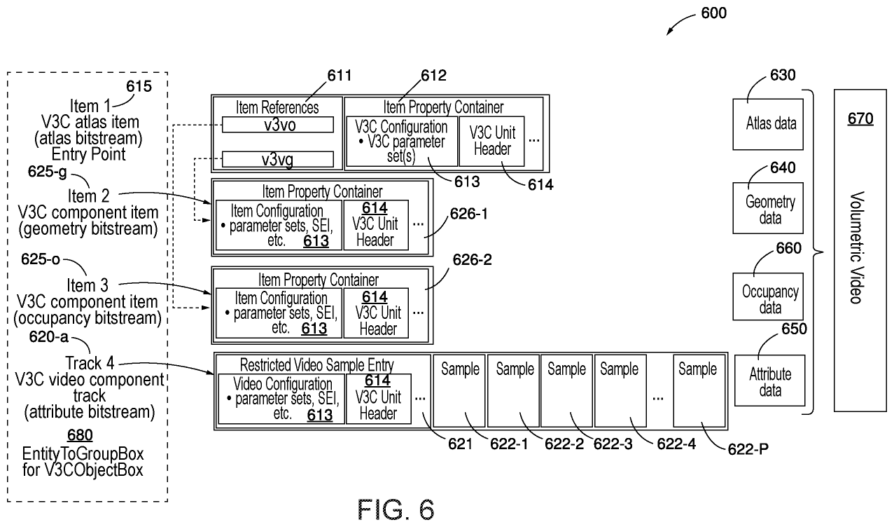

FIG. 6 is a block diagram of an example of ‘v3c’ entity to group box to indicate dependencies between non-timed items including atlas, occupancy and geometry components and a timed track that includes attribute components;

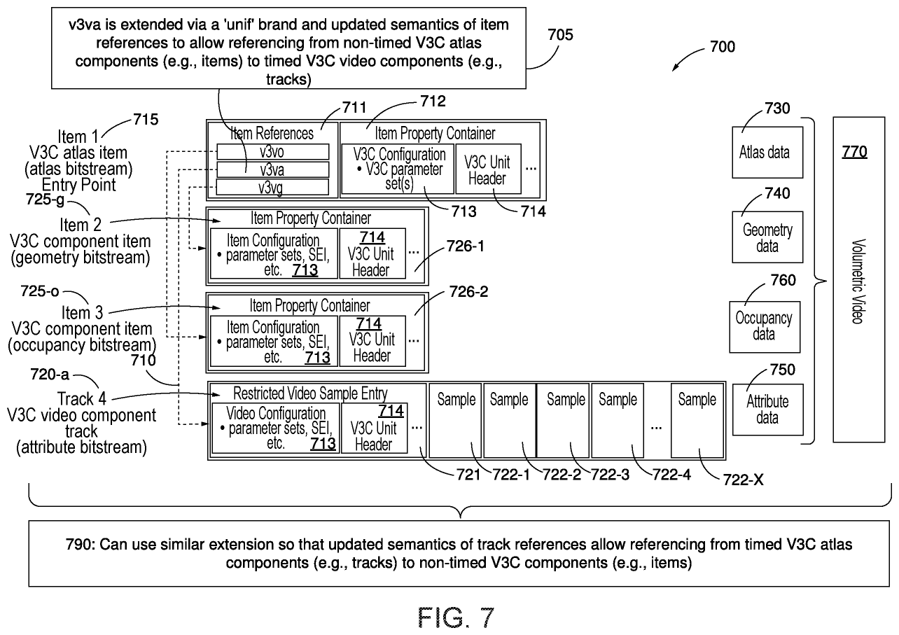

FIG. 7 is a block diagram where an example file includes a ‘unif’ brand and updated semantics of track references allow referencing from non-timed V3C atlas component to timed V3C video components;

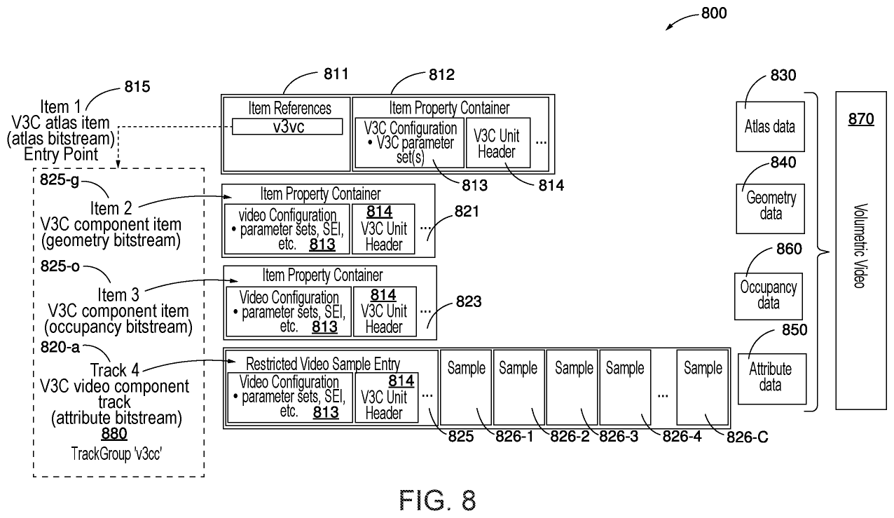

FIG. 8 is a block diagram of an example of referencing a track group ‘v3cc’ including V3C video components tracks, using v3vc track reference type;

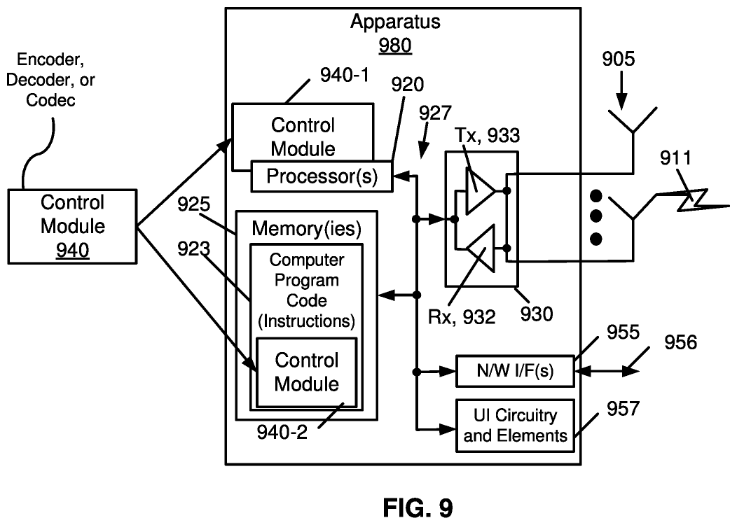

FIG. 9 is an example of a block diagram of an apparatus suitable for implementing any of the encoders or decoders described herein;

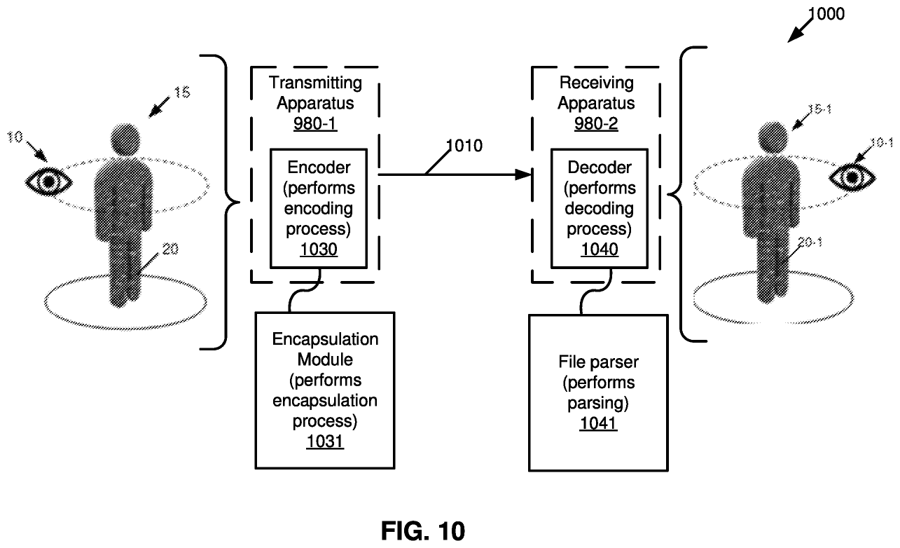

FIG. 10 is a block diagram illustrating a system in accordance with an example; and

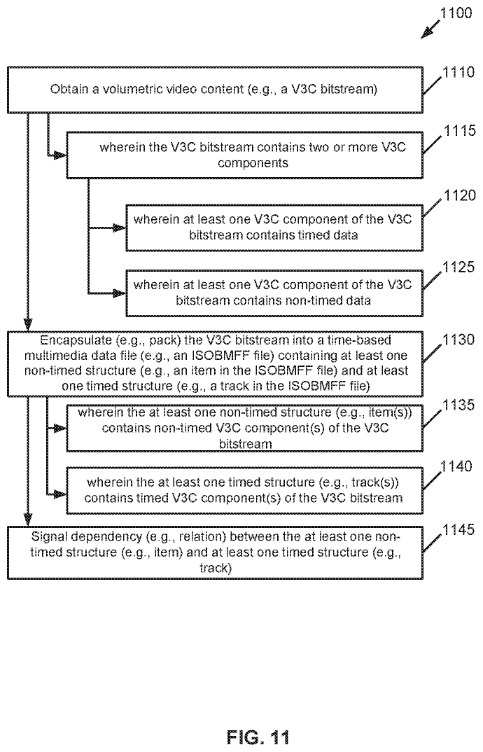

FIG. 11 is a flowchart of another example of an encapsulation process that performs encapsulation of volumetric video with static and dynamic type components

### DETAILED DESCRIPTION OF THE DRAWINGS

Abbreviations that may be found in the specification and/or the drawing figures are defined below, at the end of the detailed description section.

The word “exemplary” is used herein to mean “serving as an example, instance, or illustration.” Any embodiment described herein as “exemplary” is not necessarily to be construed as preferred or advantageous over other embodiments. All of the embodiments described in this Detailed Description are exemplary embodiments provided to enable persons skilled in the art to make or use the invention and not to limit the scope of the invention which is defined by the claims.

When more than one drawing reference numeral, word, or acronym is used within this description with “/”, and in general as used within this description, the “/” may be interpreted as “or”, “and”, or “both”.

As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

Any flow diagram (e.g., FIGS. 3, 4, and 11) or signaling diagram herein is considered to be a logic flow diagram, and illustrates the operation of an example method, results of execution of computer program instructions embodied on a computer readable memory, functions performed by logic implemented in hardware, and/or interconnected means for performing functions in accordance with an example embodiment. Block diagrams (such as FIGS. 1, 2, and 5-10) also illustrate the operation of an example method, results of execution of computer program instructions embodied on a computer readable memory, functions performed by logic implemented in hardware, and/or interconnected means for performing functions in accordance with an example embodiment.

The example embodiments herein describe techniques for encapsulation of volumetric video with static and dynamic type components. Additional description of these techniques is presented after an introduction to parts of the technical area is presented. For ease of reference, the following description is divided into sections, and the headings for those sections are not meant to be limiting and instead are examples.

The following sections include an overview of volumetric video and associated concepts. In addition to the concepts below, the following reference also includes an overview of volumetric video: Lauri Ilola, Lukasz Kondrad, Sebastian Schwarz, and Ahmed Hamza, “An Overview of the MPEG Standard for Storage and Transport of Visual Volumetric Video-Based Coding”, Front. Sig. Proc. 2:883943, doi: 10.3389/frsip.2022.883943 (2022).

### Volumetric Video

As stated above, volumetric video represents a new way of experiencing immersive media content. This refers to the process of capturing objects (e.g., people) from multiple cameras, which can be later viewed from any angle at any point in time allowing users to explore content unconstrained by the traditional two-dimensional window of a director's view. here are many ways to capture and represent a volumetric frame of volumetric video. The format used to capture and represent the volumetric frame depends on the processing to be performed on the frame, and the target application using the frame. Some example representations are listed below.
1) A volumetric frame can be represented as a point cloud. A point cloud is a set of unstructured points in 3D space, where each point is characterized by its position in a 3D coordinate system (e.g., Euclidean), and some corresponding attributes (e.g., color information provided as RGBA value, or normal vectors).
2) A volumetric frame can be represented as images, with or without depth, captured from multiple viewpoints in 3D space. In other words, the frame can be represented by one or more view frames (where a view is a projection of a volumetric scene on to a plane, e.g., the camera plane, using a real or virtual camera with known/computed extrinsics and intrinsics). Each view may be represented by a number of components (e.g., geometry, color, transparency, and occupancy picture), which may be part of the geometry picture or represented separately.
3) A volumetric frame can be represented as a mesh. A mesh is a collection of points, called vertices, and connectivity information between vertices, called edges. Vertices along with edges form faces. The combination of vertices, edges and faces can uniquely approximate shapes of objects.

Depending on the capture, a volumetric frame can provide viewers the ability to navigate a scene with six degrees of freedom, i.e., both translational and rotational movement of their viewing pose (which includes yaw, pitch, and roll). The data to be coded for a volumetric frame can also be significant, as a volumetric frame can include many objects, and the positioning and movement of these objects in the scene can result in many dis-occluded regions. Furthermore, the interaction of light and materials in objects and surfaces in a volumetric frame can generate complex light fields that can produce texture variations for even a slight change of pose.

A sequence of volumetric frames is a volumetric video. Due to the large amount of information, storage and transmission of a volumetric video requires compression. A way to compress a volumetric frame can be to project the 3D geometry and related attributes into a collection of 2D images along with additional associated metadata. The projected 2D images can then be coded using 2D video and image coding technologies, for example ISO/IEC 14496-10 (H.264/AVC) and ISO/IEC 23008-2 (H.265/HEVC). The metadata can be coded with technologies specified in specification such as ISO/IEC 23090-5. The coded images and the associated metadata can be stored or transmitted to a client that can decode and render the 3D volumetric frame.

### Visual Volumetric Video-Base Coding (V3C)—ISO/IEC 23090-5

ISO/IEC 23090-5 specifies the syntax, semantics, and process for coding volumetric video. The specified syntax is designed to be generic so that it can be reused for a variety of applications. Point clouds, immersive video with depth, and mesh representations can all use ISO/IEC 23090-5 standard with extensions that deal with the specific nature of the final representation. The purpose of the specification is to define how to decode and interpret the associated data (for example atlas data in ISO/IEC 23090-5) which tells a renderer how to interpret 2D frames to reconstruct a volumetric frame.

Two applications of V3C (ISO/IEC 23090-5) have been defined, V-PCC (ISO/IEC 23090-5) and MIV (ISO/IEC 23090-12). MIV and V-PCC use number of V3C syntax elements with a slightly modified semantics. An example on how the generic syntax element can be differently interpreted by the application is pdu_projection_id.
1) In case of V-PCC, the syntax element, pdu_projection_id, specifies the index of the projection plane for the patch. There can be 6 or 18 projection planes in V-PCC, and they are implicit, i.e., pre-determined.
2) In case of MIV, pdu_projection_id corresponds to a view ID, i.e., identifies from which view the patch originated. View IDs and their related information are explicitly provided in MIV view parameters list and may be tailored for each content.

MPEG 3DG (ISO SC29 WG7) group has started work on a third application of V3C—the mesh compression. It is also envisaged that mesh coding will re-use V3C syntax as much as possible and can also slightly modify the semantics.

To differentiate between applications of V3C bitstream, which allow a client to properly interpret the decoded data, V3C uses the ptl_profile_toolset_idc parameter.

### V3C-V3C Bitstream

A V3C bitstream is a sequence of bits that forms the representation of coded volumetric frames and the associated data making one or more coded V3C sequences (CVSs). Where CVS is a sequence of bits identified and separated by appropriate delimiters, and is required to start with a VPS, includes a V3C unit, and includes one or more V3C units with atlas sub-bitstream or video sub-bitstream. Video sub-bitstreams and atlas sub-bitstreams can be referred to as V3C sub-bitstreams. Which V3C sub-bitstream a V3C unit includes and how to interpret it is identified by a V3C unit header in conjunction with VPS information.

A V3C bitstream can be stored according to Annex C of ISO/IEC 23090-5, which specifies syntax and semantics of a sample stream format to be used by applications that deliver some or all of the V3C unit stream as an ordered stream of bytes or bits within which the locations of V3C unit boundaries need to be identifiable from patterns in the data

### Video-Based Point Cloud Compression (V-PCC)—ISO/IEC 23090-5

The generic mechanism of V3C may be used by applications targeting volumetric content. One of such application is video-based point cloud compression (ISO/IEC 20390-5). V-PCC enables volumetric video coding for application in which a scene is represented by point cloud. V-PCC uses the patch data unit concept from V3C and for each patch assign one of 6 (18) pre-defined orthogonal camera views for reprojection.

### MPEG Immersive Video (MIV)—ISO/IEC 23090-12

Another application of V3C is MPEG immersive video (ISO/IEC 23090-12). MIV enables volumetric video coding for applications in which a scene is recorded with multiple RGB (D) (red, green, blue, and optionally depth) cameras with overlapping fields of view (FoV). One example setup is a linear array of cameras pointing towards a scene. This multi-scopic view of the scene allows a 3D reconstruction and therefore 6DoF/3DoF+ consumption.

MIV uses the patch data unit concept from V3C and extends V3C by using application-specific camera views for reprojection. In contrast to V-PCC, which uses pre-defined 6 or 18 orthogonal camera views for reprojection. Additionally, MIV introduces additional occupancy packing modes and other improvements to V3C base syntax. One such example is support for multiple atlases, for example when there is too much information to pack everything in a single video frame. MIV also adds support for common atlas data, which includes information that is shared between all atlases. This is particularly useful for storing camera details of the input camera models, which are frequently shared between different atlases.

### Video-Based Dynamic Mesh Coding (V-DMC)—ISO/IEC 23090-29

V-DMC (ISO/IEC 23090-29) is another application form of V3C that aims on integration of MESH compression into the V3C family of standards. The standard is under development and at WD (working draft) stage.

The retained technology after the CfP result analysis is based on multiresolution mesh analysis and coding. This approach includes the following:
1) Generating a base mesh that is a simplified (low resolution) mesh approximation of the original mesh, called base mesh, and this is performed for all frames of the dynamic mesh sequence mi.
2) Performing several mesh subdivision iterative steps (e.g., each triangle is converted into four triangles by connecting the triangle edge midpoints on the generated base mesh), generating other approximation meshes mⁿᵢ where n stands for the number of iterations with mᵢ=m⁰ᵢ.
3) Defining displacement vectors dᵢ, also named error vectors, for each vertex of each mesh approximation mⁿᵢ with n>0, noted dⁿᵢ.
4) For each subdivision level, the deformed mesh, obtained by mⁿᵢ+dⁿᵢ, i.e., by adding the displacement vectors to the subdivided mesh vertices generates the best approximation of the original mesh at that resolution, given the base mesh and prior subdivision levels.
5) The displacement vectors may undergo a lazy wavelet transform prior to compression.
6) The attribute map of the original mesh is transferred to the deformed mesh at the highest resolution (i.e., subdivision level) such that texture coordinates are obtained for the deformed mesh and a new attribute map is generated.

The compressed bitstream generated by the encoder multiplexes the following:
1) A sub-bitstream with the encoded base mesh using a mesh codec.
2) A sub-bitstream with the encoded motion data using an animation codec for base meshes in case inter coding is enabled.
3) A sub-bitstream with the wavelet coefficients of the displacement vectors packed in an image and encoded using a video codec.
4) A sub-bitstream with the attribute map encoded using a video codec.
5) A sub-bitstream that includes all metadata required to decode and reconstruct the mesh sequence based on the aforementioned sub-bitstreams. The signaling of the metadata is based on the V3C syntax and includes necessary extensions that are specific to meshes.

The same applies in the case of multiple submeshes, for each submesh. The attribute packing and displacement packing are however modified to enable to map the data corresponding to a submesh into a dedicated attribute tile and displacement frame tile, respectively. Such tiles should be extractable and decodable independently of other tiles for each frame and for each submesh.

### ISO Base Media File Format

Available media file format standards include ISO based media file format (ISO/IEC 14496-12, which may be abbreviated ISOBMFF) and file format for NAL unit structured video (ISO/IEC 14496-15), which derives from the ISOBMFF.

Some concepts, structures, and specifications of ISOBMFF are described below as an example of a container file format, based on which the embodiments may be implemented. The aspects of the invention are not limited to ISOBMFF, but rather the description is given for one possible basis on top of which the invention may be partly or fully realized.

A basic building block in the ISO base media file format is called a box. Each box has a header and a payload. The box header indicates the type of the box and the size of the box in terms of bytes. A box may enclose other boxes, and the ISO file format specifies which box types are allowed within a box of a certain type. Furthermore, the presence of some boxes may be mandatory in each file, while the presence of other boxes may be optional. Additionally, for some box types, it may be allowable to have more than one box present in a file. Thus, the ISO base media file format may be considered to specify a hierarchical structure of boxes.

According to the ISO family of file formats, a file includes media data and metadata that are encapsulated into boxes. Each box is identified by a four character code (4CC) and starts with a header which informs about the type and size of the box.

In files conforming to the ISO base media file format, the media data may be provided in a media data ‘mdat’ box (also called MediaDataBox) and the movie ‘moov’ box (also called MovieBox) may be used to enclose the metadata. In some cases, for a file to be operable, both of the ‘mdat’ and ‘moov’ boxes may be required to be present. The movie ‘moov’ box may include one or more tracks, and each track may reside in one corresponding track ‘trak’ box (also called TrackBox). A track may be one of the many types, including a media track that refers to samples formatted according to a media compression format (and its encapsulation to the ISO base media file format).

### Sample Description

The sample description table in a track gives detailed information about the coding type used, and any initialization information needed for that coding. The syntax of the sample entry used is determined by both the format field and the media handler type.

The information stored in the SampleDescriptionBox after the entry-count is both track-type specific can also have variants within a track type (e.g., different codings may use different specific information after some common fields, even within a video track).

Which type of sample entry form is used is determined by the media handler, using a suitable form. Multiple descriptions may be used within a track.

All SampleEntry boxes may include “extra boxes” not explicitly defined in the box syntax of derived specifications. When present, such boxes should follow all defined fields and should follow any defined contained boxes. Decoders should presume a sample entry box could include extra boxes and should continue parsing as though they are present until the including box length is exhausted.

The syntax of SampleDescriptionBox is the following:

```
aligned(8) abstract class SampleEntry (unsigned int(32) format)
  extends Box(format){
  const unsigned int(8)[6] reserved = 0;
  unsigned int(16) data_reference_index;
}
class BitRateBox extends Box(‘btrt’){
  unsigned int(32) bufferSizeDB;
  unsigned int(32) maxBitrate;
  unsigned int(32) avgBitrate;
}
aligned(8) class SampleDescriptionBox ( )
  extends FullBox(‘stsd’, version, 0){
  int i ;
  unsigned int(32) entry_count;
  for (i = 1 ; i <= entry_count ; i++){
    SampleEntry( ); // an instance of a class derived from SampleEntry
  }
}
```

### Track Groups

Tracks may share a particular characteristic or a particular relationship and to indicate that ISO base media file format uses TrackGroupBox contained by a TrackBox. TrackGroupBox includes zero or more boxes, and the particular characteristic or the relationship is indicated by the box type of the contained boxes.

The contained boxes include an identifier, which can be used to conclude the tracks belonging to the same track group. The tracks that include the same type of a contained box within the TrackGroupBox and have the same identifier value within these contained boxes belong to the same track group. Track groups are not used to indicate dependency relationships between tracks. Instead, the TrackReferenceBox is used for such purposes.

The syntax of TrackGroupBox is the following:

```
aligned(8) class TrackGroupBox(‘trgr’) { }
aligned(8) class TrackGroupTypeBox(unsigned int(32) track_group_type) extends
  FullBox(track_group_type, version = 0, flags = 0)
{
  unsigned int(32) track_group_id;
  // the remaining data may be specified for a particular track_group_type
}
```

track_group_type indicates the grouping_type and should be set to one of the following values, or a value registered, or a value from a derived specification or registration.

‘msrc’ indicates that this track belongs to a multi-source presentation. The tracks that have the same value of track_group_id within a TrackGroupTypeBox of track_group_type ‘msrc’ are mapped as being originated from the same source. For example, a recording of a video telephony call may have both audio and video for both participants, and the value of track_group_id associated with the audio track and the video track of one participant differs from value of track_group_id associated with the tracks of the other participant.

The pair of track_group_id and track_group_type identifies a track group within the file. The tracks that include a particular TrackGroupTypeBox having the same value of track_group_id and track_group_type belong to the same track group.

### Alternate Tracks

ISOBMFF includes a particular feature called “alternate tracks”. This feature enables signaling any time-wise equivalent alternatives of a media. This is signaled using a particular field in the track header box (from ISOBMFF specification).

The syntax of TrackGroupBox is the following:

```
aligned(8) class TrackHeaderBox
  extends FullBox(‘tkhd’, version, flags){
  if (version==1) {
    unsigned int(64) creation_time;
    unsigned int(64) modification_time;
    unsigned int(32) track_ID;
    const unsigned int(32) reserved = 0;
    unsigned int(64) duration;
  } else { // version==0
    unsigned int(32) creation_time;
    unsigned int(32) modification_time;
    unsigned int(32) track_ID;
    const unsigned int(32) reserved = 0;
    unsigned int(32) duration;
  }
    const unsigned int(32)[2] reserved = 0;
    template int(16) layer = 0;
    template int(16) alternate_group = 0;
    template int(16) volume = {if track_is_audio 0x0100 else 0};
    const unsigned int(16) reserved = 0;
    template int(32)[9] matrix=
      { 0x00010000,0,0,0,0x00010000,0,0,0,0x40000000 };
      // unity matrix
    unsigned int(32) width;
    unsigned int(32) height;
}
```

alternate_group is an integer that specifies a group or collection of tracks. If this field is 0 (zero) there is no information on possible relations to other tracks. If this field is not 0, it should be the same for tracks that include alternate data for one another and different for tracks belonging to different such groups. Only one track within an alternate group should be played or streamed at any one time, and must be distinguishable from other tracks in the group via attributes such as bitrate, codec, language, packet size, and the like. A group may have only one member.

Typically, alternate grouping field indicates alternatives of a media track such as:
1) Different languages of the same audio track.
2) Different resolution or bitrate options of the same media track.
3) Different view of the 2D scene which is time-wise aligned with the main 2D scene (i.e., different camera angle).

Only one media track among the alternatives should be played back during the presentation time. This restriction comes from the ISOBMFF specification and the alternate_group field definition. The playback behavior for playing back multiple such media tracks is undefined.

Media players typically read the alternate grouping information and create a tree-structured information which groups the tracks together and then select the first track (i.e., lowest indexed) in the alternative tracks for initial playback. Moreover, the user can also manually switch between the alternatives.

### TrackReferenceBox

Exactly one TrackReferenceBox can be contained within the TrackBox. If this box is not present, the track is not referencing any other track in any way. The reference array is sized to fill the reference type box. TrackReferenceBox provides a reference from the including track to another track in the presentation. These references are typed using TrackReferenceTypeBoxes, where there should be at most one TrackReferenceTypeBox of a given type in a TrackReferenceBox.

The syntax of TrackReferenceBox is the following:

```
  aligned(8) class TrackReferenceBox extends Box(‘tref’) {
    TrackReferenceTypeBox [ ];
  }
  aligned(8) class TrackReferenceTypeBox (unsigned int(32) reference_type) extends
Box(reference_type) {
    unsigned int(32) track_IDs[ ];
  }
```

For example, a TrackReferenceTypeBox of reference_type ‘hint’ reference links from the including hint track to the media data that it hints, i.e., tracks indicated by the track_IDs array within TrackReferenceTypeBox.

### Sample Groups

Sample groups provide another way to describe samples and their characteristics. To use sample groups, define a group type, and then how a group is defined (the group description). The file format can then map a given sample to a single definition of a group of any given type. Defining new grouping_types and the way that they are parameterized is an important way to parameterize the file format.

The syntax of SampleToGroupBox is the following:

```
aligned(8) class SampleToGroupBox
  extends FullBox(‘sbgp’, version, 0)
{
  unsigned int(32) grouping_type;
  if (version == 1) {
    unsigned int(32) grouping_type_parameter;
  }
  unsigned int(32) entry_count;
  for (i=1; i <= entry_count; i++)
  {
    unsigned int(32) sample_count;
    unsigned int(32) group_description_index;
  }
}
```

grouping_type is an integer that identifies the type (i.e., criterion used to form the sample groups) of the sample grouping and links it to its sample group description table with the same value for grouping_type. At most one occurrence of this box with the same value for grouping_type (and, if used, grouping_type_parameter) should exist for a track.

grouping_type_parameter is an indication of the sub-type of the grouping.

entry_count is an integer that gives the number of entries in the following table.

sample_count is an integer that gives the number of consecutive samples with the same sample group descriptor. It is an error for the total in this box to be greater than the sample_count documented elsewhere, and the reader behavior would then be undefined. If the sum of the sample count in this box is less than the total sample count, or there is no SampleToGroupBox that applies to some samples (e.g., it is absent from a track fragment), then those samples are associated with the group identified by the default_group_description_index in the SampleGroupDescriptionBox, if any, or else with no group.

group_description_index is an integer that gives the index of the sample group entry which describes the samples in this group. The index ranges from 1 (one) to the number of sample group entries in the SampleGroupDescriptionBox, or takes the value 0 (zero) to indicate that this sample is a member of no group of this type.

### Items

The ISO base media file format (ISOBMFF) also allows one to store static, non-timed objects that do not require timed processing, referred to as items, meta items, or metadata items, in a ‘meta’ box (also called MetaBox). Items are contrasted with the dynamic objects, i.e., tracks in ISO base media file format that include timed sequence of related samples, and require timed processing of sample data. While the name of the meta box refers to metadata, items can generally include metadata or media data. The MetaBox may reside at the top level of the file, within a ‘moov’ box (also called MovieBox), and within a TrackBox, but at most one MetaBox may occur at each of the file level, movie level, or track level. The MetaBox may be required to include a ‘hdlr’ Handler box indicating the structure or format of the MetaBox contents. The MetaBox may list and characterize any number of items that can be referred and each one of them can be associated with a file name and can be uniquely identified with the file by item identifier (item_id) which is an integer value. The metadata items may be for example stored in the ‘idat’ box of the MetaBox or in an ‘mdat’ MediaDataBox of the same file or reside in a separate file.

### Entity Groups

Items and tracks may share a particular characteristic or a particular relationship and to indicate that ISO base media file format uses EntityToGroupBox contained by a GroupsListBox.

The Entity grouping is similar to track grouping but enables grouping of both tracks and image items in the same group. The entities in an entity group share a particular characteristic or have a particular relationship, as indicated by the grouping type.

Entity groups are indicated in GroupsListBox. Entity groups specified in GroupsListBox of a file-level MetaBox refer to tracks or file-level items. Entity groups specified in GroupsListBox of a movie-level MetaBox refer to movie-level items. Entity groups specified in GroupsListBox of a track-level MetaBox refer to track-level items of that track. When GroupsListBox is present in a file-level MetaBox, there is no item_ID value in ItemInfoBox in any file-level MetaBox that is equal to the track_ID value in any TrackHeaderBox.

The syntax of EntityToGroupBox is the following:

```
aligned(8) class EntityToGroupBox(grouping_type, version, flags)
extends FullBox(grouping_type, version, flags) {
  unsigned int(32) group_id;
  unsigned int(32) num_entities_in_group;
  for(i=0; i<num_entities_in_group; i++)
    unsigned int(32) entity_id;
}
```

group_id is a non-negative integer assigned to the particular grouping that should not be equal to any group_id value of any other EntityToGroupBox, any item_ID value of the hierarchy level (file, movie, or track) that includes the GroupsListBox, or any track_ID value (when the GroupsListBox is contained in the file level).

num_entities_in_group specifies the number of entity_id values mapped to this entity group.

entity_id is resolved to an item, when an item with item_ID equal to entity_id is present in the hierarchy level (file, movie or track) that includes the GroupsListBox, or to a track, when a track with track_ID equal to entity_id is present and the GroupsListBox is contained in the file level.

GroupsListBox includes EntityToGroupBoxes, each specifying one entity group. The four-character box type of EntityToGroupBox denotes a defined grouping type.

### Brands

ISOBMFF uses a brand, provided for example in the compatible_brands list of the FileTypeBox to inform a file reader that the file conforms to all the requirements of that brand, and give a permission to a reader implementing potentially only that brand to read the file. A brand is a four-character code, registered with ISO that identifies a precise specification to which a file complies.

The brand ‘unif’ may be used to indicate unified handling of identifiers, for example across tracks, track groups, entity groups, and file-level MetaBoxes. The consequences are the following:
1) that a given identifier identifies at most one of those (or nothing at all); for example, there is no identifier which is used to label both a track and an entity group;
2) that where an identifier is restricted, without this brand, to refer to a particular type (e.g., to a track by track_ID) that reference is no longer so restricted, and can refer to any type (e.g., to a track group), if the semantics of the reference permit it.

### Storage of V3C in ISOBMFF

Encapsulation of V3C bit stream in ISOBMFF is defined in ISO/IEC 23090-10. Encapsulation of a bitstream into a file may be defined as including or enclosing the bitstream into the file possibly with metadata that may, for example, assist in random accessing the bitstream. When encapsulating in ISOBMFF (ISO/IEC 23090-10), a V3C elementary bitstream with dynamic data is split into one V3C atlas track and number of V3C video component tracks. A V3C atlas track 110 (see FIG. 1) includes a V3C parameter set, and atlas data information. V3C video component tracks include video encoded information (occupancy 120-o, geometry 120-g, attribute 120-a, or packed). The outputs are atlas data 130, geometry data 140, attribute data 150, and occupancy data 160, which are used to form the volumetric video 170 that is output. V3C atlas track is linked to V3C video component tracks using a track reference mechanism of ISOBMFF, see FIG. 1, which is a block diagram of an overview of structure 100 for encapsulating timed V3C data with a single atlas with a single atlas tile, in accordance with ISO/IEC 23090-10. The structure 100 may be thought of as describing relations in an ISO base media file format. The structures in other FIGS. 2 and 5-8) below similarly may be thought of as describing relations in an ISO base media file format

V3C atlas tracks use V3CAtlasSampleEntry which extends VolumetricVisualSampleEntry with a sample entry type of ‘v3c1’, ‘v3cg’, ‘v3cb’, ‘v3a1’, or ‘v3ag’. To link a V3C atlas track with sample entries ‘v3c1’, ‘v3cg’, ‘v3a1’, or ‘v3ag’, or a V3C atlas tile track with sample entry ‘v3t1’ to video component tracks, the track reference tool of ISO/IEC 14496-12 is used. Some of the track reference type(s) used are described below.
1) ‘v3vo’: the referenced track(s) include the video-coded occupancy V3C component.
2) ‘v3vg’: the referenced track(s) include the video-coded geometry V3C component.
3) ‘v3va’: the referenced track(s) include the video-coded attribute V3C component.
4) ‘v3vp’: the referenced track(s) include the video-coded packed V3C component.

Each sample in a V3C atlas track 110 with sample entry of type ‘v3c1’, ‘v3cg’, ‘v3a1’, or ‘v3ag’ or V3C atlas tile track with sample entry of type ‘v3t1’ corresponds to a single coded atlas access unit or part of it. Additionally, these are a set of atlas NAL units that are associated with each other according to a specified classification rule, are consecutive in decoding order, and include all atlas NAL units pertaining to one particular output time. Under these sample entries, each sample in the V3C atlas track(s) or V3C atlas tile tracks corresponds to a coded atlas access unit associated with the same vuh_atlas_id as indicated in the V3C unit header box in the sample entry.

Each sample in a V3C atlas track with sample entry ‘v3cb’ corresponds to one or more coded common atlas access unit(s). Common atlas access unit is a set of common atlas non-ACL NAL units that are associated with each other according to a specified classification rule, are consecutive in decoding order, and include all common atlas NAL units pertaining to one particular output time.

When encapsulating in ISOBMFF (ISO/IEC 23090-10), a V3C elementary bitstream with static data is split into one V3C atlas item 215 (see FIG. 2) and number of V3C video component items 225-g, 225-a, and 225-o. V3C atlas item includes V3C Parameter Set and Atlas Data information V3C video component items include video encoded information (occupancy, geometry, attribute, or packed). V3C atlas item is linked to V3C video component items using item reference mechanism of ISOBMFF, see FIG. 2, which is a block diagram of an overview of structure 200 for encapsulating non-timed V3C data with a single atlas with a single atlas tile in accordance with ISO/IEC 23090-10). This example forms atlas data 230, geometry data 240, attribute data 250, and occupancy data 260, which are used to form non-timed V3C content 270 that may be output.

Currently ISO/IEC 23090-10 specifies how to encapsulate V3C bitstream into dynamic timed structure (i.e., tracks) and into static non-timed structure (i.e., items). Those use cases were viable for most use cases of V-PCC and MIV application of V3C. However, at least one viable use case of storage of V3C bitstream in ISOBMFF is not covered, where a mixed temporal type of V3C components (i.e., static and dynamic) can be present in a V3C bitstream and where there would be dependency between the static and dynamic components. Consider one or more of the following.
1) A use case for mixed content, where a geometry of volumetric frame is dynamic while an attribute (e.g., color) applied to the geometry is static, a possible use case for V-DMC where the texture mapping would remain the same for a sequence of frames.
2) An inverse use case for mixed content, where a geometry of volumetric frame is static while an attribute (e.g., color) applied to the geometry is dynamic. This scenario is plausible for V-PCC or MIV application, and V-DMC but it has never been considered so far. The use case could be for example for placing animated texture for a fixed geometry object, like a screen on the TV.
3) A use case where atlas data is static for the duration of the volumetric video and geometry and attribute components are changing.

V3C carriage specification (ISO/IEC 23090-10) does not provide solution on the carriage and signaling of mixed type of V3C components of V3C bitstream/content, i.e., as in the following:
1) how to encapsulate a static attribute and link it with dynamic parts of the V3C (e.g., atlas, geometry, occupancy, submesh), and/or
2) how to encapsulate a dynamic attribute and link it with static parts of the V3C (e.g., atlas, geometry, occupancy, submesh); and/or
3) how to encapsulate a dynamic attribute, geometry, occupancy, packed and link it with static parts of the V3C (atlas).

There are no known techniques for addressing these. For instance, ISO SC29/WG3 input contribution m56821 (see ISO/IEC JTC 1/SC 29/WG 3 m56821v1, April 2021)—provides entity group-based techniques for carrying thumbnails related to a video track. ISO SC29/WG3 input contribution m55780—provides techniques based on tiled thumbnail tracks. ISO/IEC 23008-12 (HEIF) subclause 6.8.1 specifies mechanism for associating untimed items to timed sequences. The ‘eqiv’ entity group and the ‘eqiv’ sample groups are defined which helps in indicating how a given untimed image relates to a particular position in the timeline of a track.

In the case of the thumbnails, the thumbnail can be displayed to end user as a preview of the video track but it is not used for the decoding of the content as in case presented for a V3C scenario. The same applies for HEIF based solution of ‘eqiv’ entity group that is not used for decoding dependency indication(s).

These examples do not address the V3C application with volumetric video that is represented by both static and dynamic components. Now that an introduction to parts of the technical area has been presented, an overview of examples is now presented.

### Overview of Examples

The example problem presented above can be solved, for example, by introducing new signaling mechanisms to indicate the dependency between V3C tracks and V3C items and, e.g., allowing mixed type V3C components in ISOBMFF file that encapsulates the V3C bitstream. Examples for encapsulation and parsing of a file that may solve, for example, the problems presented above are presented in reference to FIG. 3, FIG. 4, respectively. FIG. 11 illustrates another example for encapsulation.

Turning to FIG. 3, this figure is a flowchart of an example of encapsulation process 300 that performs encapsulation of volumetric video with static and dynamic type components. This process presented on the figure would be performed by an apparatus that implements an encapsulation process. For ease of reference, this will be described as an encapsulation module performing the blocks in FIG. 3, but the apparatus would perform the blocks by executing an encapsulation process.

In block 310, the encapsulation module obtains a volumetric video content (e.g., a V3C bitstream), wherein: the V3C bitstream includes two or more V3C components (block 315), and wherein at least one V3C component of the V3C bitstream includes timed data (block 320), and wherein at least one V3C component of the V3C bitstream includes non-timed data (block 325).

In block 330, the encapsulation process encapsulates (e.g., packs) the V3C bitstream into a time-based multimedia data file (e.g., an ISOBMFF file) including at least one non-timed structure (e.g., an item in the ISOBMFF file) and at least one timed structure (e.g., a track in the ISOBMFF file), wherein the at least one non-timed structure (e.g., item(s)) includes non-timed V3C component(s) of the V3C bitstream (block 335), and wherein the at least one timed structure (e.g. track(s)) includes timed V3C component(s) of the V3C bitstream (block 340). It should be noted that there can already be a relation between the timed and non-timed object in the V3C bitstream and then the dependency is signaled in an ISOBMFF file or other suitable file.

The encapsulation process signals in block 345 dependency (e.g., relation) between the at least one non-timed structure (e.g., item) and at least one timed structure (e.g., track), wherein the signaled dependency is from at least one non-timed structure (e.g., item) to at least one timed structure (e.g., track) (block 350) or wherein the signaled dependency is from at least one timed structure (e.g., track) to at least one non-timed structure (e.g., item) (block 355).

Now that the encapsulation has been described, a file parsing process is described in reference to FIG. 4, which is a flowchart of an example of a file parsing process 400 that decodes encapsulated volumetric video with static and dynamic type components. This figure would be performed by an apparatus that implements a file parser. For ease of reference, this will be described as a file parser performing the blocks in FIG. 4, but the apparatus would perform the blocks by executing the file parser.

In block 410, the file parser parses a time-based multimedia data file (e.g., an ISOBMFF file) including V3C bitstream, the V3C bitstream comprising an encoded presentation of two or more components of a volumetric video content. The parsing can include receiving the bitstream. The encoded presentation of two or more components of a volumetric video content may the following: wherein at least one V3C components of V3C bitstream is represented by a non-timed structure (e.g., item) (block 415), and wherein at least one V3C components of V3C bitstream is represented by a timed structure (e.g., track) (block 420).

In block 430, the file parser parses (e.g., by receiving), in or along the time-based multimedia data file (e.g., the ISOBMFF file), signaling describing dependency (e.g., relation) between the two or more components. In block 435, the file parser parses, from the ISOBMFF file, the two or more components of a volumetric video content as part of an extracted bitstream based on the parsed dependency signaling information. The extraction of the tracks and items that create the extracted bitstream is due to the signaling provided. The file parser extracts the two or more components of the volumetric video content from different components as part of the extracted bitstream in block 440, and reconstructs the 3D representation of volumetric video content from the extracted bitstream in block 445. Blocks 440 and 445 may be optional.

### Further Details

Now that an overview has been provided, further details are provided. In one embodiment, the signaling information indicating dependency (e.g., relation) between items and track(s) including V3C components comprising one V3C bitstream is provided by a new EntityToGroupBox with grouping_type equal to ‘v3c’. The group would indicate that the V3C entities, i.e., items and tracks present in the group, are creating one V3C content, i.e., originated from the same V3C bitstream. Two examples are presented on FIG. 5 and FIG. 6.

Turning to FIG. 5, this figure is a block diagram of an example of ‘v3c’ entity to group box to indicate dependencies between timed tracks including atlas and geometry components and non-timed items that includes attribute components. This example shows a structure 500 that includes a track 1 510, a V3C atlas track (atlas bitstream) that includes a track reference 511, a sample entry 512, and N samples 513-1, 513-2, . . . , 513-N. A sample entry 512 can include a V3C configuration 513 including parameter sets, SEI, and the like (etc.). The track reference 511 includes a v3vg reference to Track 2 520-g, a V3C video component track that includes a restricted video sample entry 521 and M samples 522-1, . . . , 522-M. A restricted video sample entry 521 can include video configuration 513 and V3C unit header 514. There is also an Item 3 525-a, V3C component item (attribute bitstream), which includes one or more item property containers 526, which include video configuration 513 and V3C unit header 514. The structure 500 includes atlas data 530, geometry data 540, and attribute data 550, which are used to form volumetric video 570. The EntityToGroupBox for V3CObjectBox 580 is used to link elements 510, 520-g, and 525-a and to provide dependency signaling between Track 1 510, Track 2 520-g, and Item 3 525-a.

Referring to FIG. 6, this is a block diagram of an example of ‘v3c’ entity to group box to indicate dependencies between non-timed items including atlas, occupancy and geometry components and a timed track that includes attribute components. This example shows a structure 600 that includes an Item 1 615, a V3C atlas item (atlas bitstream) that includes an item reference 611 and one or more item property containers 612, which include V3C configuration 613 and V3C unit header 614. The item references 611 have a v3vg, which references an Item 2 625-g, a V3C component item that is a geometry bitstream, which includes one or more item property containers 626-1, which include video configuration 613 and V3C unit header 614. The item references 611 also includes a v3vo, which references Item 3 625-0, a V3C component item that is an occupancy bitstream, and includes one or more item property containers 626-2, which include video configuration 613 and V3C unit header 614. There is also a Track 4 620-a, which is a V3C video component track that is an attribute bitstream, and this has a restricted video sample entry 621, and P samples 622-1, . . . , 622-P, the sample entry 621 includes video configuration 613 and V3C unit header 614. The EntityToGroupBox for V3CObjectBox 680 is used to link 615, 625-g, 625-0, and 620-a, and to signal dependency, e.g., between Item 1 615, Item 2 625-g, Item 3 625-o, and Track 4 620-a. The structure 600 further includes atlas data 630, geometry data 640, occupancy data 660, and attribute data 6850, which are used to form volumetric video 670.

The syntax of EntityToGroupBox 680 may be the following:

```
  Definition
  Box Type: ‘v3c’
  Container: GroupsListBox
  Mandatory: No
  Quantity: Zero or More
  EntityToGroupBox with grouping_type equal to ‘v3c ′ specifies tracks and items that
originated from a V3C bitstream (can be used to create volumetric video V3C object).
  aligned(8) class V3CObjectBox(version, flags)
  extends EntityToGroupBox(‘v3c ′, version, flags) {
  }
```

In one embodiment, the ‘unif’ brand would be indicated in compatible_brands when a volumetric video is stored with timed and non-timed components. Once the brand is present, referencing items from tracks can be performed with track references, and referencing tracks from items can be performed with item references. In further detail, a brand defines a set of rules which a file reader should follow. For example, support certain boxes, use some boxes in a certain way, or extend certain boxes to support additional things, these are examples of possible rules. A file reader can support multiple brands. So, in this example, a file reader supporting a ‘unif’ brand may use the ‘v3va’ item reference such that this reference may also include track identifications. In this example, the ‘unif’ brand does not replace the ‘v3va’ item reference, but can be considered to extend it. Note that it is also possible to extend a track reference in a similar way, e.g., to include item identification.

The semantics of ‘v3vo’, ‘v3va’ and ‘v3vg’ may be extended to allow referencing between items and tracks. Alternatively, new track and item references types corresponding to ‘v3vo’, ‘v3va’ and ‘v3vg’ (e.g., to ‘v3vO’, ‘v3vA’ and ‘v3vG’) are defined where the new types carry the additional semantics that referencing between items and tracks is allowed.

An example is illustrated in FIG. 7, which is a block diagram where an example a file includes a ‘unif’ brand and updated semantics of item references allow referencing from non-timed V3C atlas component to timed V3C video components. This example shows a structure 700 that includes an Item 1 715, a V3C atlas item (atlas bitstream) that includes an item reference 711 and one or more item property containers 712, which include V3C configuration 713 and V3C unit header 714. Item reference 711 includes an additional reference, v3va, which is illustrated by reference number 710 as linking to the Track 4 720-a. As indicated by block 705, the v3va is extended via a ‘unif’ brand and updated semantics of item references to allow referencing (710) from non-timed V3C atlas components (e.g., items) to timed V3C video components (e.g., tracks). The item references 711 have a v3vg, which references an Item 2 725-g, a V3C component item that is a geometry bitstream, which includes one or more item property containers 726-1, which include video configuration 713 and V3C unit header 714. The item references 711 also includes a v3vo, which references Item 3 725-0, a V3C component item that is an occupancy bitstream, and includes one or more item property containers 726-2, which include video configuration 713 and V3C unit header 714. There is also a Track 4 720-a, which is a V3C video component track that is an attribute bitstream, and this has a restricted video sample entry 721, and X samples 722-1, . . . , 721-X, sample entry 721 includes video configuration 713 and V3C unit header 714. The structure 700 further includes atlas data 730, geometry data 740, occupancy data 760, and attribute data 750, which are used to form volumetric video 770.

It is noted that FIG. 7 shows an example from an item to a track. This could, however, similarly be from a track to an item. This is illustrated by block 790, where one can use a similar extension so that updated semantics of track references allow referencing from timed V3C atlas components (e.g., tracks) to non-timed V3C components (e.g., items).

In another example, under the ‘unif’ brand, referencing a group of alternative entities from a track can be performed with a track reference to an ‘altr’ entity group, where the entity group may comprise image items or tracks, and referencing a group of alternative entities from an item can be performed with an item reference to an ‘altr’ entity group, where the entity group may comprise image items or tracks.

Alternatively, instead of ‘altr’ entity group, any other grouping type could be used, a respective track group could be used. Hereafter, such a grouping is referred to as an “alternative group”.

That is, the semantics of ‘v3vo’, ‘v3va’ and ‘v3vg’ are extended to allow referencing to alternative groups. Alternatively, new track and item references types corresponding to ‘v3vo’, ‘v3va’ and ‘v3vg’ can be defined, where the new types carry the additional semantics that referencing to alternative groups is allowed.

In a further example, under the ‘unif’ brand, referencing a group of tracks from an item can be performed with an item reference ‘v3vc’ to an ‘v3cc’ track group, where the ‘v3cc’ track group comprise V3C video components tracks. An example of this case in presented on FIG. 8. This example shows a structure 800 that includes an Item 1 815, a V3C atlas item (atlas bitstream) that includes an item references 811 and one or more item property containers 812, which include V3C configuration 813 (with V3C parameter set(s)) and V3C unit header 814. The item references 811 have a v3vc, which references a TrackGroup ‘v3cc’ 880, which has an Item 2 825-g, a V3C component item that is a geometry bitstream, which includes an item property container(s) 821, which include video configuration 813 and V3C unit header 814. The TrackGroup ‘v3cc’ 880 also includes Item 3 825-0, a V3C component item that is an occupancy bitstream, and includes property container(s) 823, which includes video configuration 813 and V3C unit header 814. The TrackGroup ‘v3cc’ 880 also has a Track 4 820-a, which is a V3C video component track that is an attribute bitstream, and this has a restricted video sample entry 825, and C samples from 826-1 to 826-C, where restricted sample entry 825 includes video configuration 813 and V3C unit header 814. The structure 800 further includes atlas data 830, geometry data 840, occupancy data 860, and attribute data 850, which are used to form volumetric video 870.

It is noted that the items in FIGS. 5-8 are themselves structures that are non-timed structures. Similarly, the tracks in FIGS. 5-8 are themselves structures that are timed structures. The structures for items are one example of non-timed structures, and the structures for tracks are one example of timed structures.

As another example, referencing a group of items from a track can be performed with an track reference ‘v3vc’ to a ‘v3cc’ entity group, where the ‘v3cc’ entity group comprise image items or tracks representing V3C components.

Consider this example, where a TrackGroupTypeBox with track_group_type equal to ‘v3cc’ indicates that track within this group includes a V3C video component. The tracks that have the same value of track_group_id within V3CComponentsGroupBox form the V3C volumetric video.

aligned(8) class V3CComponentsGroupTypeBox extends TrackGroupTypeBox(‘v3cc’)
{
}

The V3C components entity group (‘v3cc’) may indicate a non-timed V3C video component. The items for this entity group form the V3C volumetric video.

The SingleItemTypeReferenceBox, or SingleItemTypeReferenceBoxLarge, of type ‘v3vc’ item reference track group with track_group_id may be indicated in V3CComponentsGroupTypeBox.

V3CComponentsTrackReferenceTypeBox points to the entity to group with ‘v3cc’ type that includes the dependent items that form the V3C volumetric video.

```
  aligned(8) class V3CComponentsTrackReferenceTypeBox extends
TrackReferenceTypeBox (‘v3cc’)
  {
  }
```

In an additional example, the V3C tracks include have a sample group of type ‘v3c’. This sample group provides information about range of samples or time duration until which the V3C static data, i.e., V3C item in ISOBMFF, is mapped to the V3C dynamic data. This scenario would allow creating a thumbnail of V3C dynamic content, where just a portion of dynamic content is displayed to the end user, with simplified static atlas and/or geometry.

The syntax of VisualSampleGroupEntry may be the following:

```
class V3CObjectEntry( ) extends VisualSampleGroupEntry (’v3c ′)
{
  unsigned int(16) sample_count;
  unsigned int(16) time_duration;
}
```

In one embodiment, V3C items are represented by specific V3C item tracks or V3C static data track.
1) A V3C item track does not include any samples.
a) A V3C item track includes all static information in a Sample Entry of the track.
b) The V3C static data in V3C item track Sample Entry does not have duration and is valid for all duration of the dependent tracks.
c) Alternatively, V3C item track has only one sample that has duration equal to the duration of the dependent V3C track.
2) The V3C item tracks are related to V3C track(s) using references similar to the track references used in V3C tracks.
3) The V3C tracks are related to V3C item track(s) using references similar to the track references used in V3C tracks.
4) Additionally, V3C items track's dependency on V3C tracks can be performed using either entity group or track group as described in previous embodiments.
5) Additionally, V3C tracks dependency on V3C item tracks can be performed using either entity group or track group as in previous embodiments

In yet another example, a V3C item track may include more than one Sample Entry, where each Sample Entry includes static information of a given V3C component.

Turning to FIG. 9, this figure is an example of a block diagram of an apparatus suitable for implementing any of the encoders or decoders described herein. The apparatus 980 includes circuitry comprising one or more processors 920, one or more memories 925, one or more transceivers 930, one or more network (N/W) interface(s) (I/F(s)) 955 and user interface (UI) circuitry and elements 957, interconnected through one or more buses 927. Depending on implementation, some apparatus may not have all of the circuitry. For example, an apparatus 980 might not have UI circuitry and elements 957. An apparatus may have additional circuitry, not described here. FIG. 9 is presented merely as an example.

Each of the one or more transceivers 930 includes a receiver, Rx, 932 and a transmitter, Tx, 933. The one or more buses 927 may be address, data, and/or control buses, and may include any interconnection mechanism, such as a series of lines on a motherboard or integrated circuit, fiber optics or other optical communication equipment, and the like. The one or more transceivers 930 are connected to one or more antennas 905, and may communicate using wireless link 911.

The one or more memories 925 include computer program code 923. The apparatus 980 includes a control module 940, comprising one of or both parts 940-1 and/or 940-2. The control module 940 may implement an encoder, a decoder, or a codec, which implements both encoding and decoding. The control module itself may be implemented in a number of ways. The control module 940 may be implemented in hardware as control module 940-1, such as being implemented as part of the one or more processors 920. The control module 940-1 may be implemented also as an integrated circuit or through other hardware such as a programmable gate array. In another example, the control module 940 may be implemented as control module 940-2, which is implemented as computer program code (having corresponding instructions) 923 and is executed by the one or more processors 920. For instance, the one or more memories 925 store instructions that, when executed by the one or more processors 920, cause the apparatus 980 to perform one or more of the operations as described herein. Furthermore, the one or more processors 920, one or more memories 925, and example algorithms (e.g., as flowcharts and/or signaling diagrams), encoded as instructions, programs, or code, are means for causing performance of the operations described herein.

The network interface(s) (N/W I/F(s)) 955 are wired interfaces communicating using link(s) 956, which could be fiber optic or other wired interfaces. The apparatus 980 could include only wireless transceiver(s) 930, only N/W I/Fs 955, or both wireless transceiver(s) 930 and N/W I/Fs 955.

The apparatus 980 may or may not include UI circuitry and elements 957. These could include a display such as a touchscreen, speakers, or interface elements such as for headsets. For instance, an apparatus 980 of a smartphone would typically include at least a touchscreen and speakers. The UI circuitry and elements 957 may also include circuitry to communicate with external UI elements (not shown) such as displays, keyboards, mice, headsets, and the like.

The computer readable memories 925 may be of any type suitable to the local technical environment and may be implemented using any suitable data storage technology, such as semiconductor-based memory devices, flash memory, firmware, magnetic memory devices and systems, optical memory devices and systems, fixed memory and removable memory. The computer readable memories 925 may be means for performing storage functions. The processors 920 may be of any type suitable to the local technical environment, and may include one or more of general-purpose computers, special purpose computers, microprocessors, digital signal processors (DSPs) and processors based on a multi-core processor architecture, as non-limiting examples. The processors 920 may be means for performing functions, such as controlling the apparatus 980, and other functions as described herein.

Turning to FIG. 10, FIG. 10 is a block diagram illustrating a system 1000 in accordance with an example. In the example, the encoder 1030 is used to encode video from the scene 15, and the encoder 1030 is implemented in a transmitting apparatus 980-1. The encoder produces a bitstream 1010 that is received by the receiving apparatus 980-2, which implements a decoder 1040. The encoder 1030 uses the encapsulation module 1031, which implements any of the structures in FIGS. 5-8 and performs the encapsulation process (e.g., encapsulation process of FIG. 3, and/or FIG. 11), or any other elements described herein to encapsulate data, and which forms part of the bitstream 1010 signaled by the encoder 1030. The decoder 1040 forms the video for the scene 15-1, and the receiving apparatus 980-2 would present this to the user, e.g., via a smartphone, television, or projector among many other options. The decoder 1040 uses the file parser 1041, which performs parsing to perform, e.g., the parsing process in FIG. 4 and to parse the structures FIGS. 5-8 that have been received. In this example, there is a capture of 3D media from the volumetric capture at a viewpoint 10 of a scene 15, which includes a human being 20. The receiving apparatus 980-2 reproduces a version of the 3D media at a viewpoint 10-1 of a scene 15-1, which includes a human being 20-1.

Turning to FIG. 11, this figure is a flowchart of another example of encapsulation process 1100 that performs encapsulation of volumetric video with static and dynamic type components. This process presented on the figure would be performed by an apparatus that implements an encapsulation process. For ease of reference, this will be described as an encapsulation module performing the blocks in FIG. 11, but the apparatus would perform the blocks by executing an encapsulation process.

In block 1110, the encapsulation module obtains a volumetric video content (e.g., a V3C bitstream), wherein: the V3C bitstream includes two or more V3C components (block 1115), and wherein at least one V3C component of the V3C bitstream includes timed data (block 1120), and wherein at least one V3C component of the V3C bitstream includes non-timed data (block 1125).

In block 1130, the encapsulation process encapsulates (e.g., packs) the V3C bitstream into a time-based multimedia data file (e.g., an ISOBMFF file) including at least one non-timed structure (e.g., an item in the ISOBMFF file) and at least one timed structure (e.g., a track in the ISOBMFF file), wherein the at least one non-timed structure (e.g., item(s)) includes non-timed V3C component(s) of the V3C bitstream (block 1135), and wherein the at least one timed structure (e.g. track(s)) includes timed V3C component(s) of the V3C bitstream (block 1140). It should be noted that there can already be a relation between the timed and non-timed object in the V3C bitstream and then the dependency is signaled in an ISOBMFF file or other suitable file.

The encapsulation process signals in block 1145 dependency (e.g., relation) between the at least one non-timed structure (e.g., item) and at least one timed structure (e.g., track).

Without in any way limiting the scope, interpretation, or application of the claims appearing below, a technical effect and/or advantage of one or more of the example embodiments disclosed herein is the examples herein allow encapsulating a V3C bitstream with mixed type for V3C components in, e.g., ISOBMFF and address use cases that were not consider so far.

The following are additional examples.

Example 1. A method, comprising: obtaining a bitstream, wherein the bitstream comprises two or more components, wherein at least one of the two or more component of the bitstream includes timed data, and wherein at least one of the two or more components of the bitstream includes non-timed data; encapsulating the bitstream into a time-based multimedia data file including at least one non-timed structure and at least one timed structure, wherein the at least one non-timed structure includes one or more non-timed components of the bitstream, and wherein the at least one timed structure includes one or more timed components of the bitstream; and signaling dependency between one or more of the at least one non-timed structure and one or more of the at least one timed structure, wherein the signaled dependency is from the one or more non-timed structures to the one or more timed structures or is from the one or more timed structures to the one or more non-timed structures.

Example 2. A method, comprising: obtaining a bitstream, wherein the bitstream comprises two or more components, wherein at least one of the two or more component of the bitstream comprises timed data, and wherein at least one of the two or more components of the bitstream comprises non-timed data; encapsulating the bitstream into a time-based multimedia data file comprising at least one non-timed structure and at least one timed structure, wherein the at least one non-timed structure comprises one or more non-timed components of the bitstream, and wherein the at least one timed structure comprises one or more timed components of the bitstream; and signaling dependency between one or more of the at least one non-timed structure and one or more of the at least one timed structure.

Example 3. The method according to example 2, wherein the signaled dependency is from the one or more non-timed structures to the one or more timed structures or is from the one or more timed structures to the one or more non-timed structures.

Example 4. The method according to any of the examples 1 to 3, wherein the signaled dependency is between one or more timed structures comprising timed data and one or more non-timed structures that comprise non-timed data, and the signaled dependency uses a box that specifies tracks for the timed data and items for the non-timed data and a corresponding atlas bitstream, and the bitstream comprises the atlas bitstream.

Example 5. The method according to example 4, wherein the one or more timed structures comprise one or more bitstreams for corresponding one or more video component tracks, the atlas bitstream comprises atlas track information that has a corresponding link or corresponding links to the one or more bitstreams for corresponding one or more video component tracks, the one or more non-timed structures comprise a bitstream of a component item, and the signaled dependency is at least from the one or more bitstreams for the one or more video component tracks to the bitstream for the component item.

Example 6. The method according to example 4, wherein the one or more timed structures comprise one or more bitstreams for corresponding one or more items, the atlas bitstream comprises atlas item information that has a corresponding link or corresponding links to the one or more bitstreams for corresponding one or more items, the one or more non-timed structures comprise one or more bitstreams for corresponding one or more video component tracks, and the signaled dependency is from the one or more bitstreams for the corresponding one or more items to the one or more bitstreams for the corresponding one or more video component tracks.

Example 7. The method according to any of the examples 1 or 2, wherein the bitstream comprises a bitstream of an atlas item, and the signaled dependency uses semantics of one or more item references in the bitstream of the atlas item to provide referencing from non-timed structures to timed structures.

Example 8. The method according to example 7, wherein a four-character code, used to provide the signaled dependency in an item reference of the atlas item, is a certain brand that indicates a timed structure is mapped from the atlas item.

Example 9. The method according to any of the examples 1 or 2, wherein the bitstream comprises a bitstream of an atlas track, and the signaled dependency uses semantics of one or more track references in the bitstream of the atlas track to provide referencing from timed structures to non-timed structures.

Example 10. The method according to example 9, wherein a four-character code, used to provide the signaled dependency in a track reference of the atlas track, is a certain brand that indicates a non-timed structure is mapped from the atlas track.

Example 11. The method according to any of the examples 1 or 2, wherein the one or more non-timed structures comprise an attribute bitstream of an atlas item, and an item reference of atlas item references a track group that provides signaling dependency between the atlas item and any non-timed structures or timed structures that correspond to the signaling dependency.

Example 12. The method according to any of the examples 1 or 2, wherein the one or more non-timed structures comprise an attribute bitstream of an atlas track, and a track reference of the atlas track references a track group that provides signaling dependency between the atlas track and any non-timed structures or timed structures that correspond to the signaling dependency.

Example 13. The method according to any of examples 1 to 12, further comprising signaling the bitstream.

Example 14. The method according to any of examples 1 to 13, wherein the bitstream comprises a bitstream of visual volumetric video-based coding information, and wherein the two or more components are visual volumetric video-based coding components.

Example 15. The method according to any of examples 1 to 14, wherein the time-based multimedia data file comprises an ISO base media file format file, and wherein the at least one timed structure comprises a track of the ISO base media file format file, and wherein the at least one non-timed structure comprises an item of the ISO base media file format file.

Example 16. A method, comprising: receiving a time-based multimedia data file in a bitstream including at least one non-timed structure, at least one timed structure, and signaling information, wherein the at least one non-timed structure includes one or more non-timed components of the bitstream, and wherein the at least one timed structure includes one or more timed components of the bitstream, and wherein the signaling information includes dependency information between at least one non-timed structure and at least one timed structure; parsing the received time-based multimedia data file to retrieve first information, comprising the at least one non-timed structure including the one or more non-timed components of the bitstream, and to retrieve second information, comprising the at least one timed structure including the one or more timed components of the bitstream, based on a signaled dependency identified through the signaling information; and forming an extracted bitstream based on the retrieved first and second information.

Example 17. The method according to example 16, wherein the signaled dependency is between one or more timed structures comprising timed data and one or more non-timed structures that comprise non-timed data, and the signaled dependency uses a box that specifies tracks for the timed data and items for the non-timed data and a corresponding atlas bitstream, and the bitstream comprises the atlas bitstream.

Example 18. The method according to example 17, wherein the one or more timed structures comprise one or more bitstreams for corresponding one or more video component tracks, the atlas bitstream comprises atlas track information that has a corresponding link or corresponding links to the one or more bitstreams for corresponding one or more video component tracks, the one or more non-timed structures comprise a bitstream of a component item, and the signaled dependency is at least from the one or more bitstreams for the one or more video component tracks to the bitstream for the component item.

Example 19. The method according to example 17, wherein the one or more timed structures comprise one or more bitstreams for corresponding one or more items, the atlas bitstream comprises atlas item information that has a corresponding link or corresponding links to the one or more bitstreams for corresponding one or more items, the one or more non-timed structures comprise one or more bitstreams for corresponding one or more video component tracks, and the signaled dependency is from the one or more bitstreams for the corresponding one or more items to the one or more bitstreams for the corresponding one or more video component tracks.

Example 20. The method according to example 16, wherein the bitstream comprises a bitstream of an atlas item, and the signaled dependency uses semantics of one or more item references in the bitstream of the atlas item to provide referencing from non-timed structures to timed structures.

Example 21. The method according to example 20, wherein a four-character code, used to provide the signaled dependency in an item reference of the atlas item, is a certain brand that indicates a timed structure is mapped from the atlas item.

Example 22. The method according to example 16, wherein the bitstream comprises a bitstream of an atlas track, and the signaled dependency uses semantics of one or more track references in the bitstream of the atlas track to provide referencing from timed structures to non-timed structures.

Example 23. The method according to example 22, wherein a four-character code, used to provide the signaled dependency in a track reference of the atlas track, is a certain brand that indicates a non-timed structure is mapped from the atlas track.

Example 24. The method according to example 16, wherein the one or more non-timed structures comprise an attribute bitstream of an atlas item, and an item reference of the atlas item references a track group that provides signaling dependency between the atlas item and any non-timed structures or timed structures that correspond to the signaling dependency.

Example 25. The method according to example 16, wherein the one or more non-timed structures comprise an attribute bitstream of an atlas track, and a track reference of the atlas track references a track group that provides signaling dependency between the atlas track and any non-timed structures or timed structures that correspond to the signaling dependency.

Example 26. The method according to any of examples 16 to 25, further comprising receiving signaling of the bitstream.

Example 27. The method according to any of examples 16 to 26, wherein the bitstream comprises a bitstream of visual volumetric video-based coding information, and wherein the one or more non-timed components and one or more timed components are visual volumetric video-based coding components.

Example 28. The method according to any of examples 16 to 27, wherein the time-based multimedia data file comprises an ISO base media file format file, and wherein the at least one timed structure comprises a track of the ISO base media file format file, and wherein the at least one non-timed structure comprises an item of the ISO base media file format file.

Example 29. A computer program, comprising instructions for performing the methods of any of examples 1 to 28, when the computer program is run on an apparatus.

Example 30. The computer program according to example 29, wherein the computer program is a computer program product comprising a computer-readable medium bearing instructions embodied therein for use with the apparatus.

Example 31. The computer program according to example 29, wherein the computer program is directly loadable into an internal memory of the apparatus.

Example 32. An apparatus, comprising at least one processor; and at least one non-transitory memory comprising computer program code; wherein the at least one memory and the computer program code are configured to, with the at least one processor, cause the apparatus at least to perform: obtaining a bitstream, wherein the bitstream comprises two or more components, wherein at least one of the two or more component of the bitstream includes timed data, and wherein at least one of the two or more components of the bitstream includes non-timed data; encapsulating the bitstream into a time-based multimedia data file including at least one non-timed structure and at least one timed structure, wherein the at least one non-timed structure includes one or more non-timed components of the bitstream, and wherein the at least one timed structure includes one or more timed components of the bitstream; and signaling dependency between one or more of the at least one non-timed structure and one or more of the at least one timed structure, wherein the signaled dependency is from the one or more non-timed structures to the one or more timed structures or is from the one or more timed structures to the one or more non-timed structures.

Example 33. An apparatus, comprising at least one processor; and at least one non-transitory memory comprising computer program code; wherein the at least one memory and the computer program code are configured to, with the at least one processor, cause the apparatus at least to perform: obtaining a bitstream, wherein the bitstream comprises two or more components, wherein at least one of the two or more component of the bitstream comprises timed data, and wherein at least one of the two or more components of the bitstream comprises non-timed data; encapsulating the bitstream into a time-based multimedia data file comprising at least one non-timed structure and at least one timed structure, wherein the at least one non-timed structure comprises one or more non-timed components of the bitstream, and wherein the at least one timed structure comprises one or more timed components of the bitstream; and signaling dependency between one or more of the at least one non-timed structure and one or more of the at least one timed structure.

Example 34. The apparatus according to claim 33, wherein the signaled dependency is from the one or more non-timed structures to the one or more timed structures or is from the one or more timed structures to the one or more non-timed structures.

Example 35. The apparatus according to any of examples 32 or 33, wherein the signaled dependency is between one or more timed structures comprising timed data and one or more non-timed structures that comprise non-timed data, and the signaled dependency uses a box that specifies tracks for the timed data and items for the non-timed data and a corresponding atlas bitstream, and the bitstream comprises the atlas bitstream.

Example 36. The apparatus according to example 35, wherein the one or more timed structures comprise one or more bitstreams for corresponding one or more video component tracks, the atlas bitstream comprises atlas track information that has a corresponding link or corresponding links to the one or more bitstreams for corresponding one or more video component tracks, the one or more non-timed structures comprise a bitstream of a component item, and the signaled dependency is at least from the one or more bitstreams for the one or more video component tracks to the bitstream for the component item.

Example 37. The apparatus according to example 35, wherein the one or more timed structures comprise one or more bitstreams for corresponding one or more items, the atlas bitstream comprises atlas item information that has a corresponding link or corresponding links to the one or more bitstreams for corresponding one or more items, the one or more non-timed structures comprise one or more bitstreams for corresponding one or more video component tracks, and the signaled dependency is from the one or more bitstreams for the corresponding one or more items to the one or more bitstreams for the corresponding one or more video component tracks.

Example 38. The apparatus according to any of examples 32 or 33, wherein the bitstream comprises a bitstream of an atlas item, and the signaled dependency uses semantics of one or more item references in the bitstream of the atlas item to provide referencing from non-timed structures to timed structures.

Example 39. The apparatus according to example 38, wherein a four-character code, used to provide the signaled dependency in an item reference of the atlas item, is a certain brand that indicates a timed structure is mapped from the atlas item.

Example 40. The apparatus according to any of examples 32 or 33, wherein the bitstream comprises a bitstream of an atlas track, and the signaled dependency uses semantics of one or more track references in the bitstream of the atlas track to provide referencing from timed structures to non-timed structures.

Example 41. The apparatus according to example 40, wherein a four-character code, used to provide the signaled dependency in a track reference of the atlas track, is a certain brand that indicates a non-timed structure is mapped from the atlas track.

Example 42. The apparatus according to any of examples 32 or 33, wherein the one or more non-timed structures comprise an attribute bitstream of an atlas item, and an item reference of the atlas item references a track group that provides signaling dependency between the atlas item and any non-timed structures or timed structures that correspond to the signaling dependency.

Example 43. The apparatus according to any of examples 32 or 33, wherein the one or more non-timed structures comprise an attribute bitstream of an atlas track, and a track reference of the atlas track references a track group that provides signaling dependency between the atlas track and any non-timed structures or timed structures that correspond to the signaling dependency.

Example 44. The apparatus according to any of examples 32 to 43, wherein the means are further configured for performing: signaling the bitstream.

Example 45. The apparatus according to any of examples 32 to 44, wherein the bitstream comprises a bitstream of visual volumetric video-based coding information, and wherein the two or more components are visual volumetric video-based coding components.

Example 46. The apparatus according to any of examples 32 to 45, wherein the time-based multimedia data file comprises an ISO base media file format file, and wherein the at least one timed structure comprises a track of the ISO base media file format file, and wherein the at least one non-timed structure comprises an item of the ISO base media file format file.

Example 47. An apparatus comprising at least one processor; and at least one non-transitory memory comprising computer program code; wherein the at least one memory and the computer program code are configured to, with the at least one processor, cause the apparatus at least to perform: receiving a time-based multimedia data file in a bitstream including at least one non-timed structure, at least one timed structure, and signaling information, wherein the at least one non-timed structure includes one or more non-timed components of the bitstream, and wherein the at least one timed structure includes one or more timed components of the bitstream, and wherein the signaling information includes dependency information between at least one non-timed structure and at least one timed structure; parsing the received time-based multimedia data file to retrieve first information, comprising the at least one non-timed structure including the one or more non-timed components of the bitstream, and to retrieve second information, comprising the at least one timed structure including the one or more timed components of the bitstream, based on a signaled dependency identified through the signaling information; and forming an extracted bitstream based on the retrieved first and second information.

Example 48. The apparatus according to example 47, wherein the signaled dependency is between one or more timed structures comprising timed data and one or more non-timed structures that comprise non-timed data, and the signaled dependency uses a box that specifies tracks for the timed data and items for the non-timed data and a corresponding atlas bitstream, and the bitstream comprises the atlas bitstream.

Example 49. The apparatus according to example 48, wherein the one or more timed structures comprise one or more bitstreams for corresponding one or more video component tracks, the atlas bitstream comprises atlas track information that has a corresponding link or corresponding links to the one or more bitstreams for corresponding one or more video component tracks, the one or more non-timed structures comprise a bitstream of a component item, and the signaled dependency is at least from the one or more bitstreams for the one or more video component tracks to the bitstream for the component item.

Example 50. The apparatus according to example 48, wherein the one or more timed structures comprise one or more bitstreams for corresponding one or more items, the atlas bitstream comprises atlas item information that has a corresponding link or corresponding links to the one or more bitstreams for corresponding one or more items, the one or more non-timed structures comprise one or more bitstreams for corresponding one or more video component tracks, and the signaled dependency is from the one or more bitstreams for the corresponding one or more items to the one or more bitstreams for the corresponding one or more video component tracks.

Example 51. The apparatus according to example 47, wherein the bitstream comprises a bitstream of an atlas item, and the signaled dependency uses semantics of one or more item references in the bitstream of the atlas item to provide referencing from non-timed structures to timed structures.

Example 52. The apparatus according to example 51, wherein a four-character code, used to provide the signaled dependency in an item reference of the atlas item, is a certain brand that indicates a timed structure is mapped from the atlas item.

Example 53. The apparatus according to example 47, wherein the bitstream comprises a bitstream of an atlas track, and the signaled dependency uses semantics of one or more track references in the bitstream of the atlas track to provide referencing from timed structures to non-timed structures.

Example 54. The apparatus according to example 53, wherein a four-character code, used to provide the signaled dependency in a track reference of the atlas track, is a certain brand that indicates a non-timed structure is mapped from the atlas track.

Example 55. The apparatus according to example 47, wherein the one or more non-timed structures comprise an attribute bitstream of an atlas item, and an item reference of the atlas item references a track group that provides signaling dependency between the atlas item and any non-timed structures or timed structures that correspond to the signaling dependency.

Example 56. The apparatus according to example 47, wherein the one or more non-timed structures comprise an attribute bitstream of an atlas track, and a track reference of the atlas track references a track group that provides signaling dependency between the atlas track and any non-timed structures or timed structures that correspond to the signaling dependency.

Example 57. The apparatus according to any of examples 47 to 55, wherein the means are further configured for performing: receiving signaling of the bitstream.

Example 58. The apparatus according to any of examples 47 to 56, wherein the bitstream comprises a bitstream of visual volumetric video-based coding information, and wherein the one or more non-timed components and one or more timed components are visual volumetric video-based coding components.

Example 59. The apparatus according to any of examples 47 to 57, wherein the time-based multimedia data file comprises an ISO base media file format file, and wherein the at least one timed structure comprises a track of the ISO base media file format file, and wherein the at least one non-timed structure comprises an item of the ISO base media file format file.

Example 60. An apparatus, comprising: one or more processors; and one or more memories storing instructions that, when executed by the one or more processors, cause the apparatus at least to perform: obtaining a bitstream, wherein the bitstream comprises two or more components, wherein at least one of the two or more component of the bitstream includes timed data, and wherein at least one of the two or more components of the bitstream includes non-timed data; encapsulating the bitstream into a time-based multimedia data file including at least one non-timed structure and at least one timed structure, wherein the at least one non-timed structure includes one or more non-timed components of the bitstream, and wherein the at least one timed structure includes one or more timed components of the bitstream; and signaling dependency between one or more of the at least one non-timed structure and one or more of the at least one timed structure, wherein the signaled dependency is from the one or more non-timed structures to the one or more timed structures or is from the one or more timed structures to the one or more non-timed structures.

Example 61. An apparatus, comprising: one or more processors; and one or more memories storing instructions that, when executed by the one or more processors, cause the apparatus at least to perform: receiving a time-based multimedia data file in a bitstream including at least one non-timed structure, at least one timed structure, and signaling information, wherein the at least one non-timed structure includes one or more non-timed components of the bitstream, and wherein the at least one timed structure includes one or more timed components of the bitstream, and wherein the signaling information includes dependency information between at least one non-timed structure and at least one timed structure; parsing the received time-based multimedia data file to retrieve first information, comprising the at least one non-timed structure including the one or more non-timed components of the bitstream, and to retrieve second information, comprising the at least one timed structure including the one or more timed components of the bitstream, based on a signaled dependency identified through the signaling information; and forming an extracted bitstream based on the retrieved first and second information.

As used in this application, the term “circuitry” may refer to one or more or all of the following:
(a) hardware-only circuit implementations (such as implementations in only analog and/or digital circuitry) and
(b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Embodiments herein may be implemented in software (executed by one or more processors), hardware (e.g., an application specific integrated circuit), or a combination of software and hardware. In an example embodiment, the software (e.g., application logic, an instruction set) is maintained on any of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted, e.g., in FIG. 9. A computer-readable medium may comprise a computer-readable storage medium (e.g., memories 925 or other device) that may be any media or means that can contain, store, and/or transport the instructions for use by or in connection with an instruction execution system, apparatus, or device, such as a computer. A computer-readable storage medium does not comprise propagating signals, and therefore may be considered to be non-transitory. The term “non-transitory”, as used herein, is a limitation of the medium itself (i.e., tangible, not a signal) as opposed to a limitation on data storage persistency (e.g., RAM, random access memory, versus ROM, read-only memory).

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

The following abbreviations that may be found in the specification and/or the drawing figures are defined as follows:
2D two-dimensional
3D three-dimensional
3DG 3D Graphics Coding group
4CC four character code
CfP call for proposal
CVS coded V3C sequences
FoV field of view
HEIF high efficiency image file format
ID identification
ISOBMFF ISO base media file format
MIV MPEG Immersive video
MPEG motion picture experts group
NAL Network Abstraction Layer
RGBA red, green, blue, alpha
RGB (D) red, green, blue, and optionally depth
V3C Visual Volumetric Video-based Coding
V-PCC Video-based point cloud compression
WD working draft
WG working group

1-61. (canceled)

62. A method, comprising:
obtaining a bitstream, wherein the bitstream comprises two or more components, wherein at least one of the two or more components of the bitstream comprises timed data, and wherein at least one of the two or more components of the bitstream comprises non-timed data;
encapsulating the bitstream into a time-based multimedia data file comprising at least one non-timed structure and at least one timed structure, wherein the at least one non-timed structure comprises one or more non-timed components of the bitstream, and wherein the at least one timed structure comprises one or more timed components of the bitstream; and
signaling a dependency between one or more of the at least one non-timed structure and one or more of the at least one timed structure.

63. The method according to claim 62, wherein the dependency is from the one or more non-timed structures to the one or more timed structures or is from the one or more timed structures to the one or more non-timed structures.

64. The method according to claim 62, wherein the bitstream comprises a bitstream of an atlas item, and the dependency uses semantics of one or more item references in the bitstream of the atlas item to provide referencing from non-timed structures to timed structures.

65. The method according to claim 62, wherein a four-character code comprising a certain brand that indicates a timed structure may be mapped from the atlas item.

66. The method according to claim 62, wherein the bitstream comprises a bitstream of an atlas track, and the dependency uses semantics of one or more track references in the bitstream of the atlas track to provide referencing from timed structures to non-timed structures.

67. The method according to claim 62, wherein a four-character code comprising is a certain brand that indicates a non-timed structure may be mapped from the atlas track.

68. The method according to claim 62, wherein the bitstream comprises a bitstream of visual volumetric video-based coding information, and wherein the two or more components are visual volumetric video-based coding components.

69. The method according to claim 62, wherein the time-based multimedia data file comprises an International Organization for Standardization (ISO) base media file format file, and wherein the at least one timed structure comprises a track of the ISO base media file format file, and wherein the at least one non-timed structure comprises an item of the ISO base media file format file.

70. A method, comprising:
receiving a time-based multimedia data file in a bitstream comprising at least one non-timed structure, at least one timed structure, and signaling information, wherein the at least one non-timed structure comprises one or more non-timed components of the bitstream, and wherein the at least one timed structure comprises one or more timed components of the bitstream, and wherein the signaling information comprises dependency between at least one non-timed structure and at least one timed structure.

71. The method according to claim 70 further comprising:
parsing the received time-based multimedia data file to retrieve first information, comprising the at least one non-timed structure comprising the one or more non-timed components of the bitstream, and to retrieve second information, comprising the at least one timed structure comprising the one or more timed components of the bitstream, based on the dependency; and
forming an extracted bitstream based on the retrieved first and second information.

72. An apparatus comprising at least one processor; and at least one non-transitory memory comprising computer program code; wherein the at least one non-transitory memory and the computer program code are configured to, with the at least one processor, cause the apparatus at least to perform:
obtaining a bitstream, wherein the bitstream comprises two or more components, wherein at least one of the two or more components of the bitstream comprises timed data, and wherein at least one of the two or more components of the bitstream comprises non-timed data;
encapsulating the bitstream into a time-based multimedia data file comprising at least one non-timed structure and at least one timed structure, wherein the at least one non-timed structure comprises one or more non-timed components of the bitstream, and wherein the at least one timed structure comprises one or more timed components of the bitstream; and
signaling a dependency between one or more of the at least one non-timed structure and one or more of the at least one timed structure.

73. The apparatus according to claim 72, wherein the dependency is from the one or more non-timed structures to the one or more timed structures or is from the one or more timed structures to the one or more non-timed structures.

74. The apparatus according to claim 72, wherein the bitstream comprises a bitstream of an atlas item, and the dependency uses semantics of one or more item references in the bitstream of the atlas item to provide referencing from non-timed structures to timed structures.

75. The apparatus according to claim 72, wherein a four-character code comprising a certain brand that indicates a timed structure may be mapped from the atlas item.

76. The apparatus according to claim 72, wherein the bitstream comprises a bitstream of an atlas track, and the dependency uses semantics of one or more track references in the bitstream of the atlas track to provide referencing from timed structures to non-timed structures.

77. The apparatus according to claim 72, wherein a four-character code comprising is a certain brand that indicates a non-timed structure may be mapped from the atlas track.

78. The apparatus according to claim 72, wherein the bitstream comprises a bitstream of visual volumetric video-based coding information, and wherein the two or more components are visual volumetric video-based coding components.

79. The apparatus according to claim 72, wherein the time-based multimedia data file comprises an International Organization for Standardization (ISO) base media file format file, and wherein the at least one timed structure comprises a track of the ISO base media file format file, and wherein the at least one non-timed structure comprises an item of the ISO base media file format file.

80. An apparatus comprising at least one processor; and at least one non-transitory memory comprising computer program code; wherein the at least one non-transitory memory and the computer program code are configured to, with the at least one processor, cause the apparatus at least to perform:
receiving a time-based multimedia data file in a bitstream comprising at least one non-timed structure, at least one timed structure, and signaling information, wherein the at least one non-timed structure comprises one or more non-timed components of the bitstream, and wherein the at least one timed structure comprises one or more timed components of the bitstream, and wherein the signaling information comprises dependency between at least one non-timed structure and at least one timed structure.

81. The apparatus according to claim 80, wherein the apparatus is further caused to perform:
parsing the received time-based multimedia data file to retrieve first information, comprising the at least one non-timed structure comprising the one or more non-timed components of the bitstream, and to retrieve second information, comprising the at least one timed structure comprising the one or more timed components of the bitstream, based on the dependency; and
forming an extracted bitstream based on the retrieved first and second information.
